(19) United States
(12) Patent Application Publication
(10) Pub. No.: US 2023/0124395 A1
(43) Pub. Date: Apr. 20, 2023

(54) SYSTEM AND METHODS FOR DETECTING FORCES IN OR ON AN OBJECT

(71) Applicants: Evan Haas, Bucyrus, KS (US); Nathan Bennett, Plano, TX (US)

(72) Inventors: Evan Haas, Bucyrus, KS (US); Nathan Bennett, Plano, TX (US)

(21) Appl. No.: 17/827,597

(22) Filed: May 27, 2022

Related U.S. Application Data
(60) Provisional application No. 63/193,812, filed on May 27, 2021.

(51) Int. Cl. G06T 7/246; G01L 5/16; G06T 7/11; G06T 7/73

(52) U.S. Cl. CPC G06T 7/246; G01L 5/16; G06T 7/11; G06T 7/73

(57) ABSTRACT

A system including at least one object and a computing system. The computing system includes a tracking system configured to detect the object. The tracking system may include a camera or other recording device. The computing system determines at least one attribute of the object based on input from the tracking system.

### CROSS-REFERENCE TO RELATED APPLICATIONS

The present application claims the benefit of U.S. Provisional Patent Application No. 63/193,812, filed May 27, 2021, the disclosure of which is incorporated herein by reference in its entirety.

### TECHNICAL FIELD

The present disclosure relates generally to detecting forces in or on an object, and more particularly relates to systems and methods for detecting forces in an object using an electronic device.

### BACKGROUND

Materials include attributes that may be of interest to professionals, students, and/or others in a variety of professions. For example, some attributes of interest may include the motion, velocity, acceleration, height, width, depth, rotation, orientation, weight, distance, location, relative location, displacement, temperature, orientation, deformation, stress, and/or strain of a material. Some professions or others in consumer industries may need to quickly ascertain some of the attributes of interest. For example, professors teaching certain courses may need to demonstrate concepts associated with the attributes of interest to demonstrate a physical concept. Specifically, when teaching about torsion and strain, a professor may need to demonstrate strain by imparting a force on an object and measuring the results of the force on the attributes of interest. Additionally, when designing new materials, an engineer may need to quickly ascertain the attributes of interest of the material to determine if the material is worth further study. Accordingly, there is a need for a digital, quick system for determining attributes of interest in a material.

### SUMMARY

The disclosed technology includes a system including at least one object and a computing system. The computing system includes a tracking system configured to detect the object. The computing system determines at least one attribute of the object based on input from the tracking system.

In some embodiments, a method of detecting properties of at least one object with a system is provided. The system includes the at least one object, a tracking system, and a computer system. The method includes capturing frames of the at least one object, wherein the tracking system comprises at least one camera and the at least one camera captures the frames of the object. The method also includes segmenting the object from an environment, wherein the computer system segments and isolates the object from the environment. The method further includes segmenting at least one surface feature from the object. The method also includes determining a position of the at least one surface feature. The method further includes determining at least one property of the at least one object using the computing system.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates a block diagram of an example force detection system in accordance with aspects of the present disclosure.

FIG. 2 illustrates a perspective view of an embodiment of an object of the force detection system shown in FIG. 1 in accordance with aspects of the present disclosure.

FIG. 3 illustrates a perspective view of another embodiment of an object of the force detection system shown in FIG. 1 in accordance with aspects of the present disclosure.

FIG. 4 illustrates a perspective view of another embodiment of an object of the force detection system shown in FIG. 1 in accordance with aspects of the present disclosure.

FIG. 5 illustrates a perspective view of another embodiment of an object of the force detection system shown in FIG. 1 in accordance with aspects of the present disclosure.

FIG. 6 illustrates a side view of the object of the force detection system shown in FIG. 5 in accordance with aspects of the present disclosure.

FIG. 7 illustrates a side view of the object of the force detection system shown in FIG. 5 in accordance with aspects of the present disclosure.

FIG. 8 illustrates a perspective view of another embodiment of an object of the force detection system shown in FIG. 1 in accordance with aspects of the present disclosure.

FIG. 9 illustrates a side view of the object of the force detection system shown in FIG. 8 in accordance with aspects of the present disclosure.

FIG. 10 illustrates a perspective view of another embodiment of an object of the force detection system shown in FIG. 1 in accordance with aspects of the present disclosure.

FIG. 11 illustrates a side view of the object of the force detection system shown in FIG. 10 in accordance with aspects of the present disclosure.

FIG. 12 illustrates a perspective view of another embodiment of an object of the force detection system shown in FIG. 1 in accordance with aspects of the present disclosure.

FIG. 13 illustrates a side view of the object of the force detection system shown in FIG. 12 in accordance with aspects of the present disclosure.

FIG. 14 illustrates a perspective view of another embodiment of an object of the force detection system shown in FIG. 1 in accordance with aspects of the present disclosure.

FIG. 15 illustrates a perspective view of another embodiment of an object of the force detection system shown in FIG. 1 in accordance with aspects of the present disclosure.

FIG. 16 illustrates another perspective view of the object of the force detection system shown in FIG. 15 in accordance with aspects of the present disclosure.

FIG. 17 illustrates a perspective view of another embodiment of an object of the force detection system shown in FIG. 1 in accordance with aspects of the present disclosure.

FIG. 18 illustrates another perspective view of the object of the force detection system shown in FIG. 17 in accordance with aspects of the present disclosure.

FIG. 19 illustrates a perspective view of a system of objects of the force detection system shown in FIG. 1 in accordance with aspects of the present disclosure.

FIG. 20 illustrates a side view of the system of objects of the force detection system shown in FIG. 19 in accordance with aspects of the present disclosure.

FIG. 21 illustrates another side view of the system of objects of the force detection system shown in FIG. 19 in accordance with aspects of the present disclosure.

FIG. 22 illustrates a perspective view of a system of objects of the force detection system shown in FIG. 1 in accordance with aspects of the present disclosure.

FIG. 23 illustrates a side view of the system of objects of the force detection system shown in FIG. 22 in accordance with aspects of the present disclosure.

FIG. 24 illustrates another side view of the system of objects of the force detection system shown in FIG. 1 in accordance with aspects of the present disclosure.

FIG. 25 illustrates another side view of the system of objects of the force detection system shown in FIG. 1 in accordance with aspects of the present disclosure.

FIG. 26 illustrates a perspective view of an object of the force detection system shown in FIG. 1 in accordance with aspects of the present disclosure.

FIG. 27 illustrates a perspective view of an object of the force detection system shown in FIG. 1 in accordance with aspects of the present disclosure.

FIG. 28 illustrates a perspective view of an object of the force detection system shown in FIG. 1 in accordance with aspects of the present disclosure.

FIG. 29 illustrates a perspective view of an object of the force detection system shown in FIG. 1 in accordance with aspects of the present disclosure.

FIG. 30 illustrates another perspective view of the object of the force detection system shown in FIG. 29 in accordance with aspects of the present disclosure.

FIG. 31 illustrates another perspective view of the object of the force detection system shown in FIG. 29 in accordance with aspects of the present disclosure.

FIG. 32 illustrates a perspective view of a manipulation device of the force detection system shown in FIG. 1 in accordance with aspects of the present disclosure.

FIG. 33 illustrates a side view of the manipulation device shown in FIG. 32 in accordance with aspects of the present disclosure.

FIG. 34 illustrates a perspective view of a manipulation device of the force detection system shown in FIG. 1 in accordance with aspects of the present disclosure.

FIG. 35 illustrates a side view of the manipulation device shown in FIG. 34 in accordance with aspects of the present disclosure.

FIG. 36 illustrates a flow diagram of a method of detecting properties of an object in accordance with aspects of the present disclosure.

FIG. 37 illustrates plots generated of the objects shown in FIGS. 2-25 in accordance with aspects of the present disclosure.

FIG. 38 illustrates a plot generated of the objects shown in FIGS. 2-25 in accordance with aspects of the present disclosure.

FIG. 39 illustrates a plot generated of the objects shown in FIGS. 2-25 in accordance with aspects of the present disclosure.

FIG. 40 illustrates a plot generated of the objects shown in FIGS. 2-25 in accordance with aspects of the present disclosure.

FIG. 41 illustrates a plot generated of the objects shown in FIGS. 28-31 in accordance with aspects of the present disclosure.

FIG. 42 illustrates a plot generated of the objects shown in FIGS. 28-31 in accordance with aspects of the present disclosure.

FIG. 43 illustrates a plot generated of the objects shown in FIGS. 28-31 in accordance with aspects of the present disclosure.

FIG. 44 illustrates a plot generated of the objects shown in FIGS. 2-25 in accordance with aspects of the present disclosure.

FIG. 45 illustrates a plot generated of the objects shown in FIGS. 2-25 in accordance with aspects of the present disclosure.

FIG. 46 illustrates a plot generated of the objects shown in FIGS. 2-25 in accordance with aspects of the present disclosure.

FIG. 47 illustrates a plot generated of the objects shown in FIGS. 2-25 in accordance with aspects of the present disclosure.

FIG. 48 illustrates a plot generated of an optimization of the objects shown in FIGS. 2-25 in accordance with aspects of the present disclosure.

FIG. 49 illustrates a plot generated of an optimization of the objects shown in FIGS. 2-25 in accordance with aspects of the present disclosure.

FIG. 50 illustrates a display shown on an interactive user interface of a user manipulating the objects shown in FIGS. 2-25 in accordance with aspects of the present disclosure.

FIG. 51 illustrates a display shown on an interactive user interface of a user manipulating the objects shown in FIGS. 2-25 in accordance with aspects of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Embodiments of the present disclosure relate generally to detecting forces in an object and, more specifically, to learning, teaching, and training devices, and more particularly relates to mixed reality teaching tools utilizing physical objects. The present disclosure is primarily used within advanced education courses in the realm of science, physics, and engineering. Secondarily, the present disclosure has applications within commercial training, feedback and tracking of physical and occupational therapy, strength and conditioning training, prototyping, and solid modeling applications. Additionally, the present disclosure has applications within a wide variety of industries and situations where a trackable object is used and feedback is given to the user. The teaching tool embodiments disclosed herein may have a trackable physical object, a system to measure one or multiple attributes of the object, and a digital interface from which the user receives feedback.

The trackable physical object(s) utilized for learning, teaching, and training will be referenced as “the object”, “object”, or “objects” for the remainder of the detailed description, specifications and claims. The aforementioned attributes being tracked may be the motion, velocity, acceleration, height, width, depth, rotation, orientation, weight, distance, location, relative location, displacement, temperature, thermal conductivity, specific heat capacity, orientation, deformation, stress, strain, mass, stiffness, modulus, Poisson's ratio, strength, and/or elongation of the object(s) and/or any number of points on the object. These attributes will be referred to as attributes of interest for the remainder of the detailed description, specifications, and claims. The aforementioned feedback as part of the digital interface may be given in the form of, but not limited to, data, graphs, plots, diagrams, tables, descriptions, auditory indications, text indications, haptic feedback, and/or mixed reality feedback.

The object may be manipulated by the user when interacting with the program. The material of the object may be any of or combination of the following, but not limited to: plastic, metal, wood, paper, natural textiles, synthetic textiles, composite materials, rubber, foam, ceramics. This object's material may have features that allow for it to change characteristics in response to external stimuli such as, but not limited to, force, temperature, electric charge, magnetic field, and/or stress. This object may be trackable through any number of the means described below.

In some embodiments, the object may contain markings which may be any number of shapes including, but not limited to, circles, squares, triangles, rectangles, pluses, stars, asterisks, QR Codes, and/or Bar Codes. These markings may be used to determine the attributes of interest of the object. These markings may be changes in characteristics such as, but not limited to, color, density, reflectivity, texture, shape, smoothness, material or any other change that differentiates the marking from the rest of the material. These markings may have the ability to change characteristics in response to external stimuli such as, but not limited to, force, electric charge, magnetic field, or temperatures. In other embodiments, the object may be distinguishable enough to be tracked without special markings. The shape of the object may vary and might include cylinders, spheres, prisms, tubes, beams, I-beams, C-channels, or any variety of shapes or combination of shapes.

The object may be deformable, and the surface markings may act as indicators of the object's attributes of interest. The object may be nondeformable (rigid) and these surface markings may act as indicators of the object's attributes of interest. These markings may also act as indicators of the distance the object is from the camera. These objects may also interact with another object or objects through one or multiple connectors, simple contact, threaded connectors, snap fits, or any other method of interaction. One or more of these objects may be analyzed individually or as a group, to track any of the object's attributes of interest. The characteristics of the object as well as the markings may be utilized by the tracking system to distinguish the object from the environment and to determine the desired attributes. These objects may be tracked individually, or with respect to one another, or combined as a system. These physical objects may be created by the user or by another entity. The object(s) may have features that allow for the changing of characteristics of the object to effect one or more of, but not limited to, the following characteristics: modulus of elasticity, stiffness, weight, heat transfer coefficient, Poisson's ratio, height, thickness, depth, attachment type, attachment point, spring stiffness, and/or natural frequency. These changes may be achieved through any of, but not limited to, the following: addition of material to the physical object, coatings, sleeves, bases, fixtures, weights, inflation, deflation, and/or tensioners.

In some embodiments, the object may be a brightly colored foam cylinder of known physical properties, with markings along the outside face comprising of squares and plusses. These markings may be used to determine orientation, depth, local deformation, and motion of the object. In another embodiment, the object might be a foam beam with a partial slit through the long axis in which strips of plastic can be inserted to increase the overall stiffness of the beam. This beam may be tracked as a whole or in combination with a similar beam adjoined through attachment at the slit. In other embodiments, the object may be any number of different shapes with or without markings or varying patterns. This object may also interact with other shapes and may attach in any number of ways at one or multiple locations. These objects may or may not have the ability to change properties through any number of features and adjustments.

This system for tracking the attributes of interest of the object may utilize one or multiple of the following: cameras (including, but not limited to, computer cameras, tablet cameras, document cameras, webcams, mixed reality headset cameras, and cellphone cameras), LiDAR, infrared, sonar, ultrasound, coded light, time of flight, or any other sensor available. The tracking system may utilize multiple steps to produce useful outputs. The tracking system may distinguish the object(s) from the environment. In some embodiments, the tracking system may measure and/or calculate the object's attributes of interest. In alternative embodiments, the user may input one or more of the object's attributes of interest or the tracking system may include a database of attributes of interest of a plurality of objects. In another embodiment, the user may enter in one or multiple of the attributes of interest. In another embodiment, the system may utilize algorithms to determine one or multiple attributes of interest. In other embodiments, the tracking system may acquire the object's attributes of interest using any method that enables the system to operate as described herein.

The object may be distinguished from the environment through one or multiple of, but not limited to, the following methods such as color, shape, depth, location, orientation, motion, background removal, and/or machine learning techniques. The object(s) distinguished may be analyzed by the system to determine the object's attributes of interest. Measuring of the attributes of interest may require further segmentation of the object's markings through any of the previously listed methods. The attributes of interest of the object may be calculated utilizing one or multiple calculations in the areas of, but not limited to, Finite Element Analysis, Mechanics of Materials, Statics, Thermodynamics, Heat Transfer, Fluid Mechanics, Chemistry, Control Systems, Dynamics, System Modeling, Physics, Geometry, Trigonometry, Numerical Methods, and/or Calculus, but may also be interpreted and approximated by simplified theories, approximation, modeling, or machine learning.

These attributes of interest may be measured directly or one or more of the attributes of interest may be combined to calculate or approximate other attributes of interest. In some embodiments the tracking system may use a combination of segmentation methods such as color, size, and shape from a camera and proximity data from a LiDAR or infrared sensor to isolate the object from the environment. The object may then be further segmented to locate its' markings. These markings may then be analyzed in relation to one another and utilized to predict changes in deformation while the object is loaded. These deformations may then be utilized by the digital interface to provide feedback to the user. In another embodiment, machine learning may be utilized in segmentation of the image from a camera to track an object from its environment. The segmentation may be analyzed for observed changes in shape during loading to determine loading characteristics and in combination with manual user entry of environmental conditions, the system may give feedback to the user. In other embodiments, an object may be located using image recognition and matching techniques. The markings may be isolated, and their colors may be analyzed to determine the relative temperature of the node locations and feedback may be provided to the user. In other embodiments, the object may or may not be segmented from the background utilizing other techniques to gather the needed attributes of interest. Any number of techniques could be used to segment, track, locate, or measure these attributes. Multiple steps or combinations of steps may be employed in the gathering of the desired attributes. These attributes may be fully or partly provided by the user.

The digital interface may give feedback to the user about the object's attributes of interest. In some embodiments, the interface may display attributes beyond those directly measured by the tracking system or derived from one or more of the measured object's attributes of interest. In some embodiments the interface may be dynamic, updated live as the user manipulates the object, or in other embodiments the interface may be static after the user has completed the manipulation of the object. The manipulation of the objects may include one or multiple of, but not limited to, the following: compression, tension, torsion, bending, heating, cooling, touching, moving, squeezing, moving of fluids around or through the object, connecting objects together, throwing, dropping, translating, and/or rotating. The digital interface may be a website, application, virtual reality scenes, augmented reality objects, or any other digital interface. The user may interact with the digital interface to display information desired based on learning, teaching, or training objectives. The digital interface may instruct the user on the desired manipulation or allow the user to freely manipulate the object. The interface may also augment elements in the physical or virtual environment as means of guidance or learning. The digital interface may also allow the user to change characteristics about the object virtually to affect the relation of the characteristics to the displayed values. Additionally, the digital interface may allow the user to define characteristics of the object to reflect changes made to the object, the specific object selected, or the intended manipulation of the object. The digital interface may allow the user to manually input manipulation data without manipulation of the object and the digital interface will reflect the specified conditions.

Elements of the digital interface may be customizable by the user. In one embodiment, a website may be used to display feedback to the user. The website may allow for the user to select which plots to display as they manipulate the object. In other embodiments, the website may contain input fields for a user to select a value for a material property, force applied, temperature, or other characteristics. In other embodiments, the digital interface may be any number of different means of providing feedback such as applications, virtual reality devices, augmented reality devices, tablets, laptops, phones, or any electronic device capable of providing feedback to the user. The display of the information to the user could be any form relevant to the subject or objective of the intended lesson or activity.

One example embodiment of the invention may be a learning tool for Engineering courses. The course may include modules for Axial Stress, Torsional Stress, Transverse Shear Stress, Bending Stress, Elemental Normal Stress, Elemental Shear Stress, Buckling, Elemental Shear, Elemental Strain, Combined Loading, Mors Circle, Principal Stress Directions, Indeterminate Loading, Stress-Strain Curves, Thermal Deformations, Pressure Vessels, and/or Beam Deformation. In these modules within the example embodiment, the object may be a cylindrical beam. The object may be tracked by a camera on a computer or smartphone. The background may be filtered out using color, and the object may be isolated using geometry and location. Markings on the object may be in the shape of squares and plusses and may be isolated using color and geometry to determine the values of the attributes of interest of the object. The interface may instruct the user on how to manipulate the object, for example within Axial Loading the interface may describe how to apply a compression or tension load to the object. Once the camera is turned on and the load is applied, the interface may calculate the deformation, stresses, and strains throughout the object. Some of these values, such as deformation, may be approximated by measured locations from the tracking system, while other values, such as stress, may be calculated using a combination of measurements and calculations. These measured and calculated attributes of interest may be displayed on 2D and 3D plots. These plots may update live as the beam is manipulated by the user. Specific calculations may be used to disregard any change in depth of the beam from the camera, and any tilt of the entire beam with respect to the camera, so that results are not incorrectly displayed. Additional sections within the interface may include descriptions of plots, important equations, real-world examples, quizzing features, descriptions of key assumptions, explanatory graphics, and walk-through tutorials. Variables such as Poisson's Ratio or cross sectional shape can be altered by the user within the interface, and the outputs reflect the change in characteristics.

Another embodiment of the invention may be within additional educational courses. The object, or markings on the object, may have the ability to change color as they change temperature. The user may then use a laptop to use the tracking system, which will monitor and track the color of the object. It may also track the corresponding temperature at any point on the object. Heat may be applied by an outside source in a variety of ways, and temperature gradients may be tracked and displayed to the user through the system's feedback.

Another embodiment of the invention may be within Physics courses. Objects such as masses, dampeners, and/or springs may be isolated and tracked using LiDAR or a camera. The masses, dampeners, and springs may be connected, and the user may have the ability to disconnect and reconnect different masses, dampeners, and springs. Each mass, dampener, and spring may have differing shapes, colors, or distinguishing features for the system to distinguish. Alternatively, the user may input which spring and mass has been chosen for the trial. The system may track the velocity, acceleration, or frequency of these objects when in motion. It may also calculate other attributes of interest such as force applied, acceleration, or dampening of a system. The objects may be manipulated by the user, and the objects may be tracked by a computer camera to provide feedback to the user.

Another embodiment of the system may be in physical therapy for the rehabilitation of a patient with a shoulder injury. The object may have the ability to change mass though the addition of layers on the surface or inserts within the object. The object may have surface markings to indicate the mass of the object and aid in recognition and orientation of the object. The user may set up a laptop so that the camera is facing the user. The system may then track the object and provide mixed reality feedback through the digital interface to provide guidance for the user for the motion desired of the object. It may also track the acceleration of the object and the number of repetitions.

Another embodiment may be in the application of occupational therapy where the user desires to increase the strength and control of their hands after an injury. The user may set up their phone camera to track the object, a deformable sphere. The sphere has colored markings on the surface which the image system tracks as the user squeezes the object and the tracking system determines the force applied as well as the magnitude of deformation. The digital interface tracks progress of the users training as well as displays the optimal forces for the users training.

In other embodiments, the object or objects may have different characteristics and may be made of different materials with different features. These objects may be intended to aid in the learning, teaching, and training of the user or by the user. These objects may be tracked through any number of means and attributes of interest may in whole or in part be determined from the tracking of the object. The digital interface may provide feedback to aid in the learning, teaching, and training of the user or by the user.

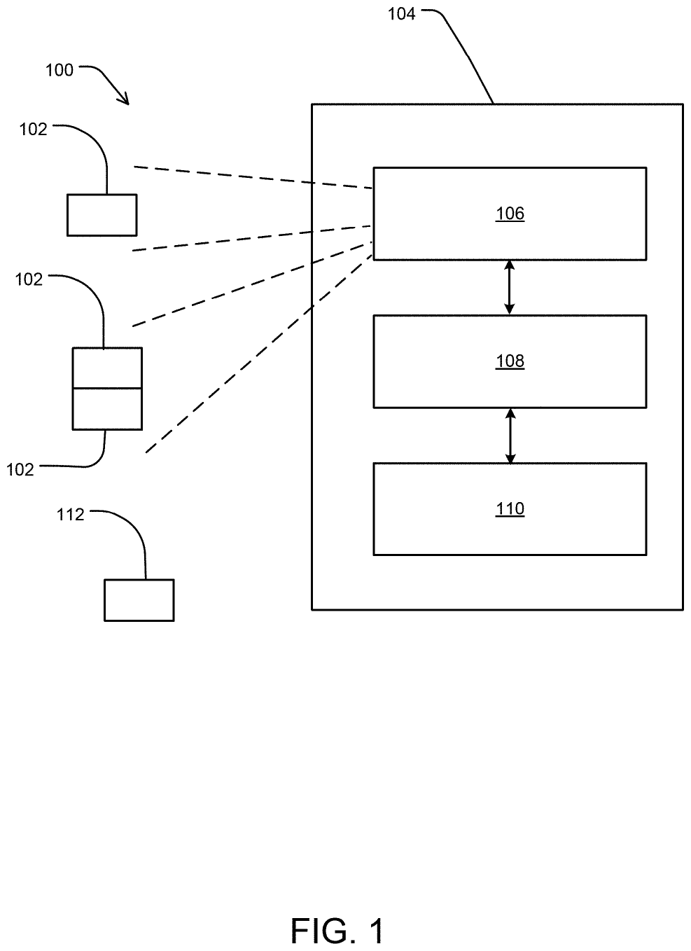

FIG. 1 is a block diagram of a force detection system 100. The force detection system 100 include an object 102 and a computing system 104. The object 102 may be at least one trackable physical object or a plurality of trackable physical objects as shown in FIG. 1. The computing system 104 may include a tracking system 106, a computing device 108, and a display device 110. In some embodiments, the tracking system 106, the computing device 108, and the display device 110 may be integrated into a single device such as, but not limited to, tablets, laptops, phones, desktop computers, and/or any electronic device that includes the tracking system 106, the computing device 108, and the display device 110 as described herein. In some embodiments, the tracking system 106, the computing device 108, and the display device 110 may be separate components configured to communicate with each other to execute the methods described herein.

In the illustrated embodiment, the tracking system 106 typically includes cameras (including, but not limited to, computer cameras, tablet cameras, document cameras, and cellphone cameras, mixed reality headset cameras), LiDAR, infrared, sonar, ultrasound, coded light, structured light, time of flight, and/or any other sensor. As discussed above, in some embodiments, the tracking system 108 may be integrated with the computing device 108, and/or the display device 110. For example, if the computing system 104 includes a laptop computer, the tracking system 106 may include the laptop computer's camera. In other embodiments, the tracking system 108 may be separate from the computing device 108, and/or the display device 110. For example, if the computing system 104 includes a laptop computer, the tracking system 106 may not utilize the laptop computer's camera. Rather, the tracking system 106 may include an exterior device or camera that includes the tracking system 106. Specifically, the exterior device or camera may include a LiDAR system that detects the object 102. Additionally, the exterior device or camera may include a vehicle or other device that includes the tracking system 106 as described herein. For example, the exterior device or camera may include a drone or a remotely operated vehicle that includes the tracking system 106 as described herein.

The computing device 108 may include any device capable of receiving input from the tracking system 106 and/or the display device 110 and executing the methods described herein. As previously discussed, the computing device 108 may be integrated with the tracking system 106 and/or the display device 110 or may be separate from the tracking system 106 and/or the display device 110. The computing device 108 may include tablets, laptops, phones, desktop computers, and/or any electronic device capable of executing the methods described herein.

The display device 110 may include any device capable of receiving input from the tracking system 106 and/or the computing device 108 and executing the methods described herein. Specifically, the display device 110 may include any device capable of receiving input from the tracking system 106 and/or the computing device 108 and displaying data received from the tracking system 106 and/or the computing device 108. As previously discussed, the display device 110 may be integrated with the tracking system 106 and/or the computing device 108 or may be separate from the tracking system 106 and/or the computing device 108. The computing device 108 may include a screen of tablets, laptops, phones, desktop computers, and/or any electronic device capable of executing the methods described herein. Additionally, the display device 110 may include a touch screen of tablets, laptops, phones, desktop computers, mixed reality headsets, virtual reality headsets, and/or any electronic device capable of executing the methods described herein and may provide input to the tracking system 106 and/or the computing device 108.

Additionally, the force detection system 100 may optionally include a manipulation device 112 that manipulates the object 102. For example, the manipulation device 112 may include a device that imparts a force on the object 102 that the computing system 104 detects and analyzes as described herein. The manipulation device 112 may include any device that enables the systems and methods describe herein to operate as described herein.

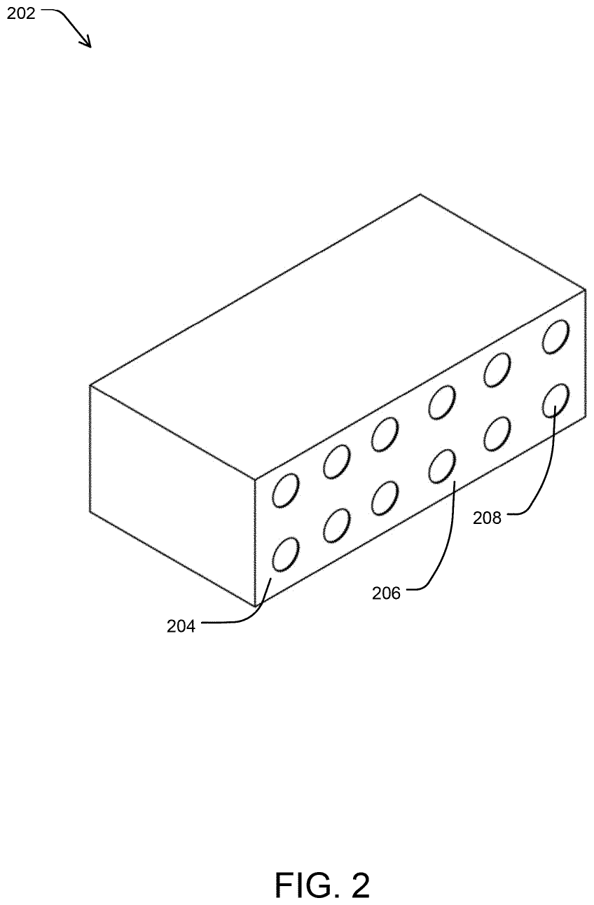

FIGS. 2-31 illustrate embodiments of the object 102 including objects 202-2902. Each of the objects 202-2902 includes a tracked body and a surface feature. The tracked body includes an object tracked by the tracking system 106 of any shape that is interacted with by the user or an external system. The object can be deformable or act as a rigid body. The surface feature includes any trackable surface mark, texture, shape, or physical feature that is used in the measurement, tracking, or identification of the tracked body. The tracked body may include any geometric shape, or combination of geometric shapes, containing surface features. The tracked body may include a deformable or rigid body.

FIG. 2 illustrates a perspective view of an object 202. In the illustrated embodiment, the object 202 has a rectangular prism shape, and includes at least one surface 204 that corresponds to a tracked body 206. The surface 204 includes twelve surface features 208 in the shapes of circles on the surface 204. This specific embodiment of the object 202 may be used in situations where the software is tracking twelve nodes or surface features 208 on the surface 204, and there is no additional differentiation needed between the nodes or surface features 208. This configuration may contain variations of color between the components. Each surface feature 208 may be printed in a distinct color to differentiate between the nodes or surface features 208 on the object. Conversely, all surface nodes or surface features 208 may be the same color if this additional layer of tracking is not needed.

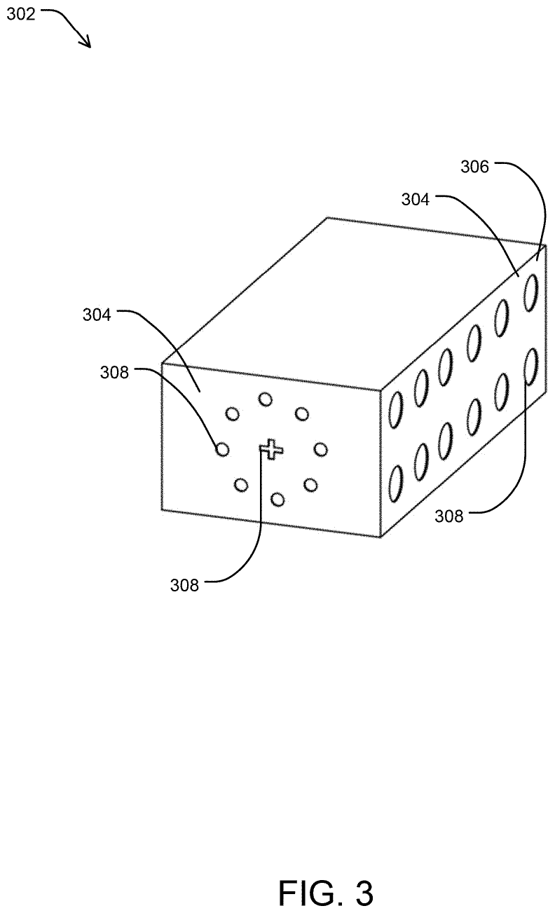

FIG. 3 illustrates a perspective view of an object 302. In the illustrated embodiment, the object 302 also has a rectangular prism shape, and includes at least one surface 304 that corresponds to a tracked body 306 including surface features 308. The surface features 308 may be found on any surface 304 of the object 302 and can be arranged in any pattern or shape. In the illustrated embodiment, the object 302 includes surface features 308 on a plurality of surfaces 304. The surface features 308 may also vary in size and shape to further differentiate the specific surfaces 304 of the object 302. In the illustrated embodiment, the surface features 308 include large circles, small circles, and one cross on the object 302. The surface features 308 may include any size, shape, and/or color that enables the software to determine the angle of orientation the object 302 has with respect to the tracking system 106. These additional variables within the surface features 308 may create more segmentation possibilities when tracking.

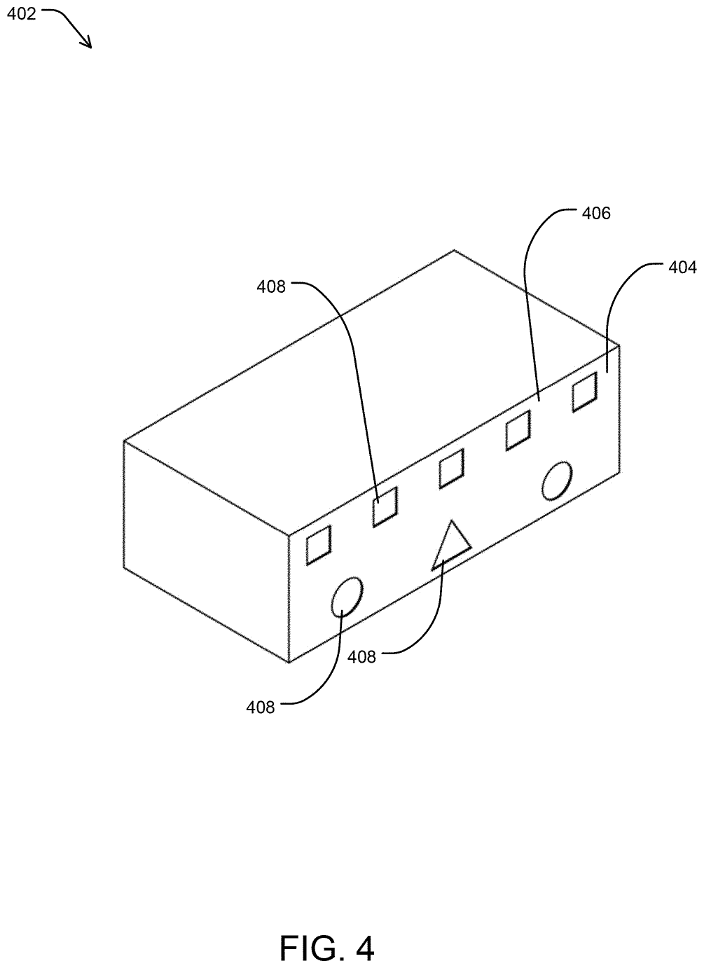

FIG. 4 illustrates a perspective view of an object 402. In the illustrated embodiment, the object 402 also has a rectangular prism shape, and includes at least one surface 404 that corresponds to a tracked body 406 including surface features 408. The surface features 408 may include a mixture of different shapes, textures, styles, and sizes. In the illustrated embodiment, the surface features 408 of different shapes, textures, styles, and sizes allows for better tracking, segmentation, and detail to be applied within the software and calculations.

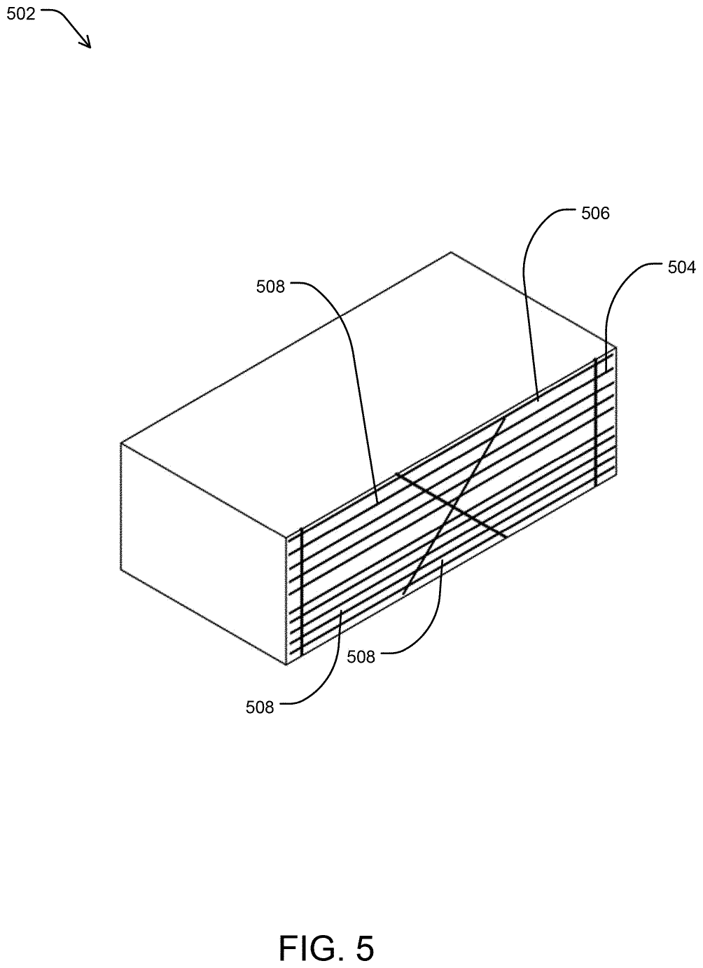

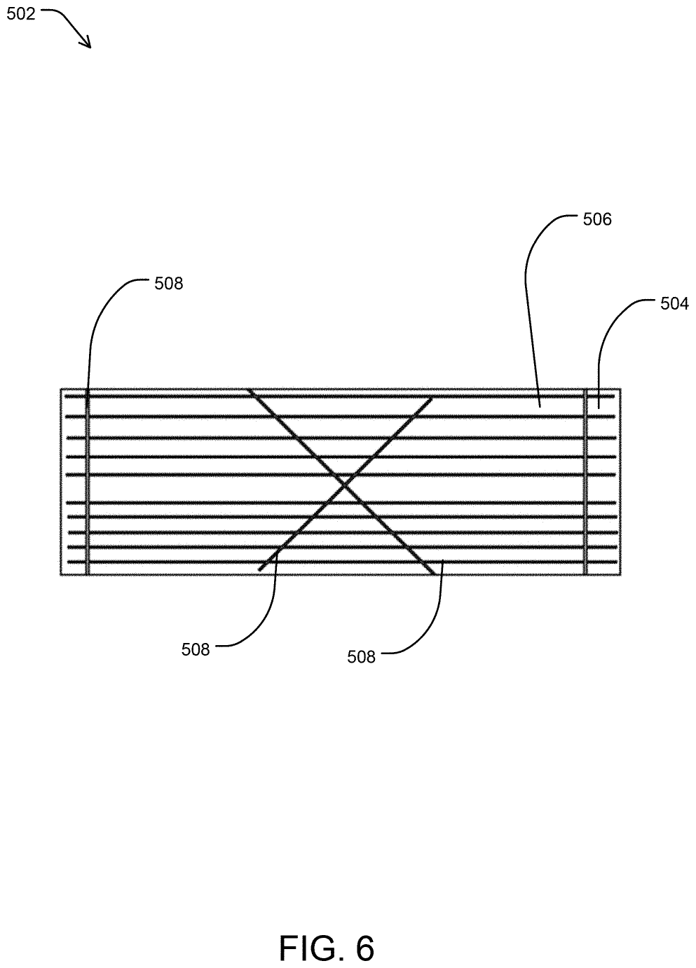

FIG. 5 illustrates a perspective view of an object 502. FIG. 6 illustrates a side view of the object 502. In the illustrated embodiment, the object 502 also has a rectangular prism shape, and includes at least one surface 504 that corresponds to a tracked body 506 including surface features 508. The surface features 508 may include discrete or continuous marking. In the illustrated embodiment, the surface features 508 may intersect and may take the form of lines or paths as opposed to discrete points and/or shapes. The illustrated embodiment allows for continuous tracking along a line of interest on the tracked body and may be more useful than analyzing specific points for some calculations. The surface features 508 may intersect and be oriented at any angle or orientation relative to each other and/or the object 502. In the illustrated embodiment, the angles can be utilized directly to calculate the deformation or other changes in the object 502. Creating intersecting lines at specified angles creates a baseline of no load and, when a load is applied or action is taken, the change in angle can be directly observed and calculated using vectors. This method can be used while measuring discrete points on an object and creating vectors from one to another, but this can also be applied to intersecting vectors on an object to simplify the process.

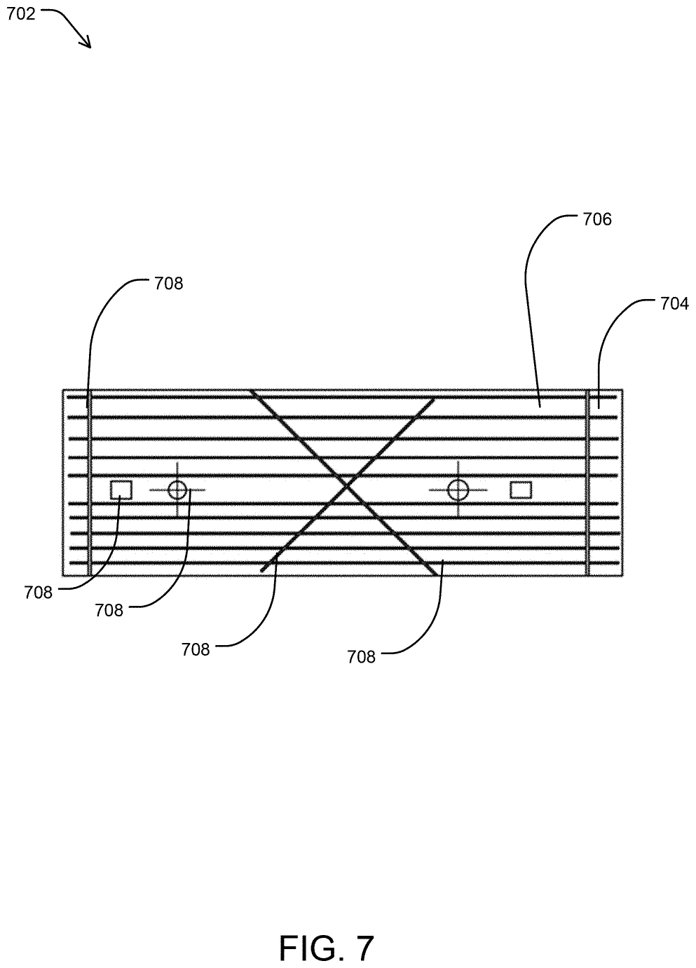

FIG. 7 illustrates a side view of an object 702. In the illustrated embodiment, the object 702 also has a rectangular prism shape, and includes at least one surface 704 that corresponds to a tracked body 706 including surface features 708. Combinations of surface feature styles can be utilized together. Hybrid configurations may be most useful when there are specific angles of interest as well as points of interest. Various surface markings may be used to indicate and measure those values of interest, and several styles of surface features can be used on the same object.

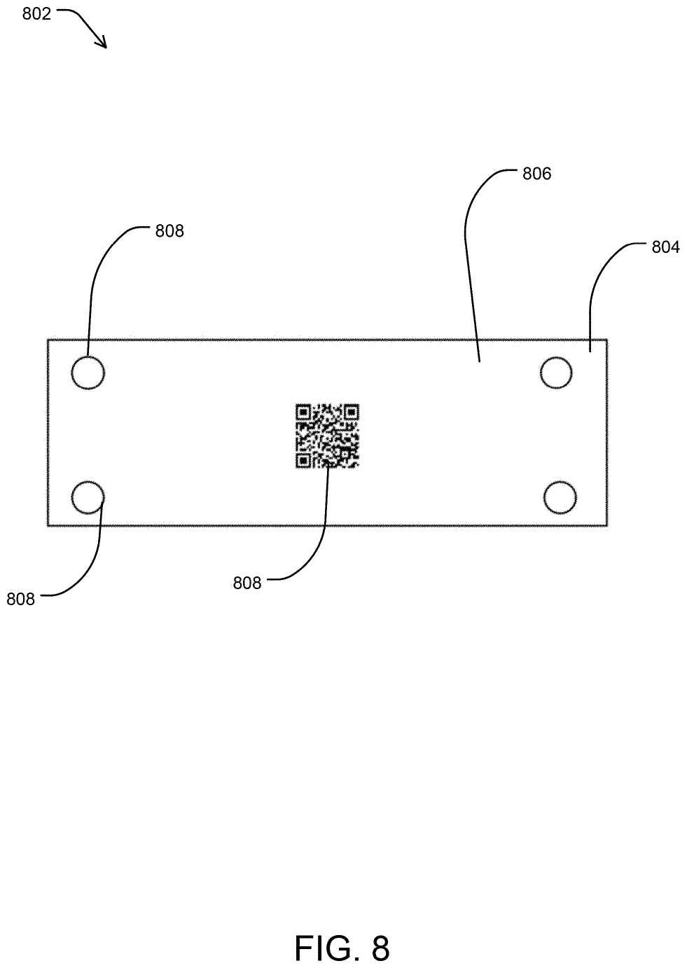

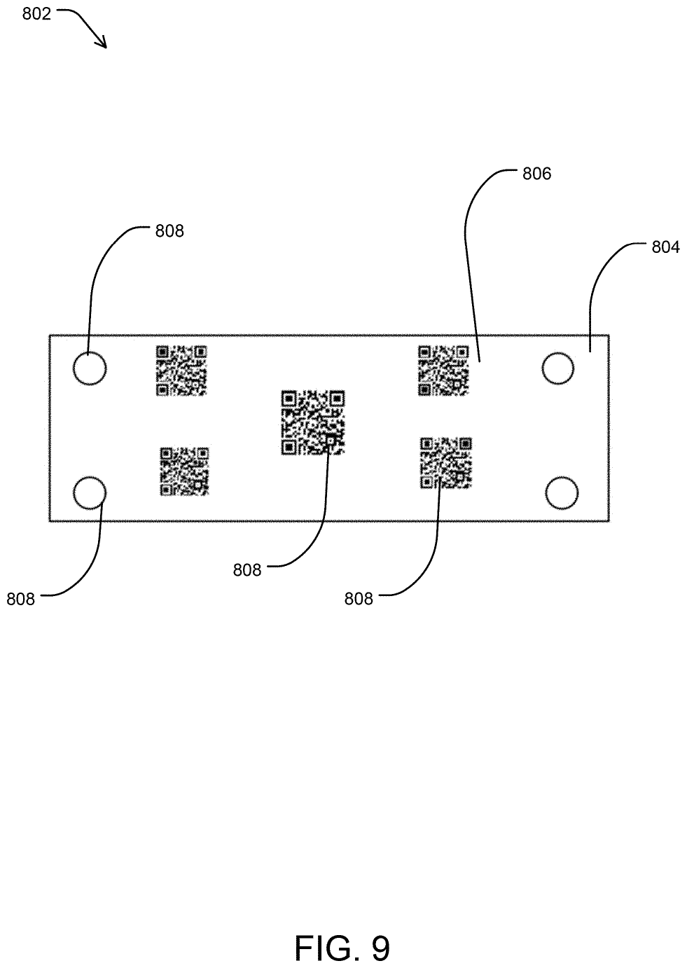

FIG. 8 illustrates a perspective view of an object 802. FIG. 9 illustrates a side view of the object 802. In the illustrated embodiment, the object 802 also has a rectangular prism shape, and includes at least one surface 804 that corresponds to a tracked body 806 including surface features 808. The surface features 508 may include a complex pattern, such as a QR code. The surface features 808 can be utilized in the recognition of the object 802 for registration purposes and can be used in determining the object orientation, tracking, sizing, or other metrics of interest. A complex pattern such as a QR code can have a variety of functions, such as: determining the size of the object, determining the distance from the camera, or linking an object to a specific web-based asset. Complex patterns can be used in conjunction with simple patterns to create a hybrid configuration to optimize the tracking of a specific object 802.

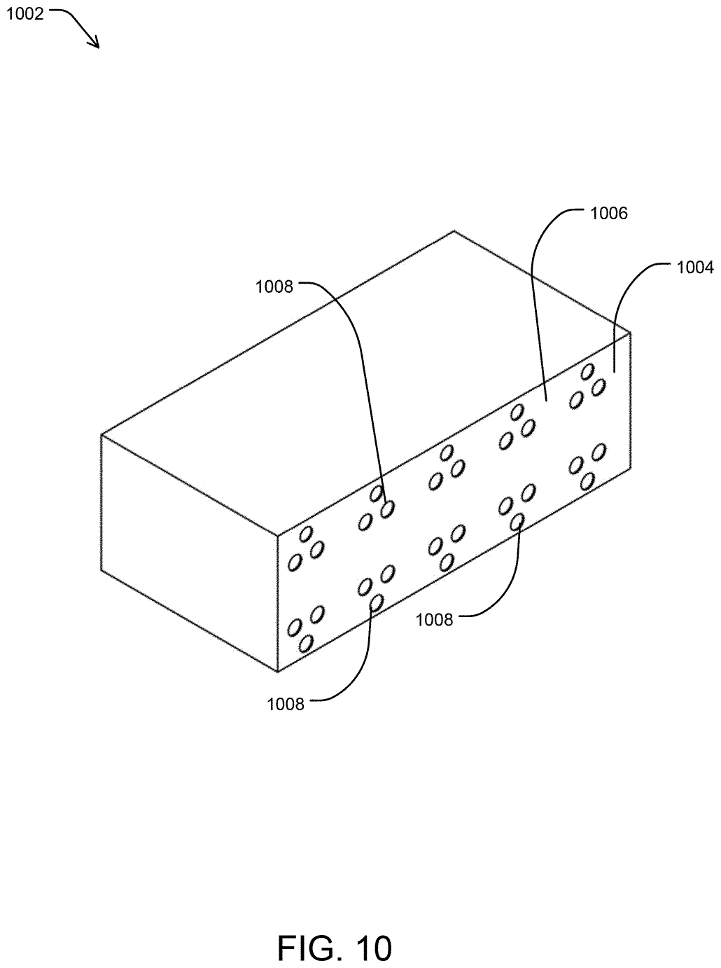

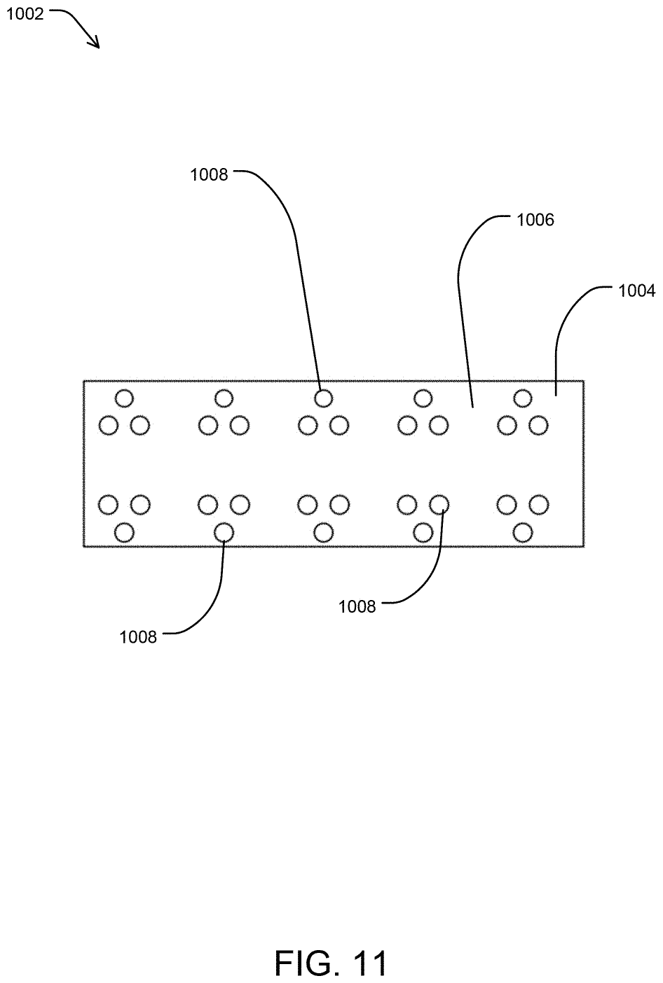

FIG. 10 illustrates a perspective view of an object 1002. FIG. 11 illustrates a side view of the object 1002. In the illustrated embodiment, the object 1002 also has a rectangular prism shape, and includes at least one surface 1004 that corresponds to a tracked body 1006 including surface features 1008. The surface features 1008 may be grouped into sub-features of any number of surface features 1008. These sub-features can be used to measure localized distances and deformations, as well as compare the localized values across different areas of the object 1002. In some cases, this technique may produce more in-depth observations, and may be helpful to generate additional plots and draw additional conclusions on the tracked body.

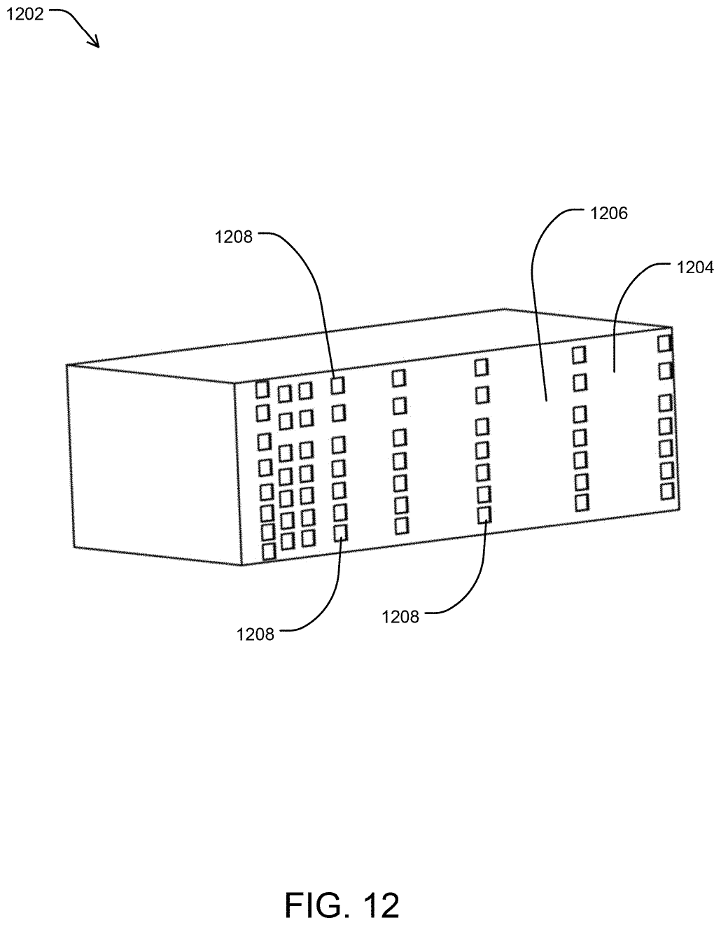

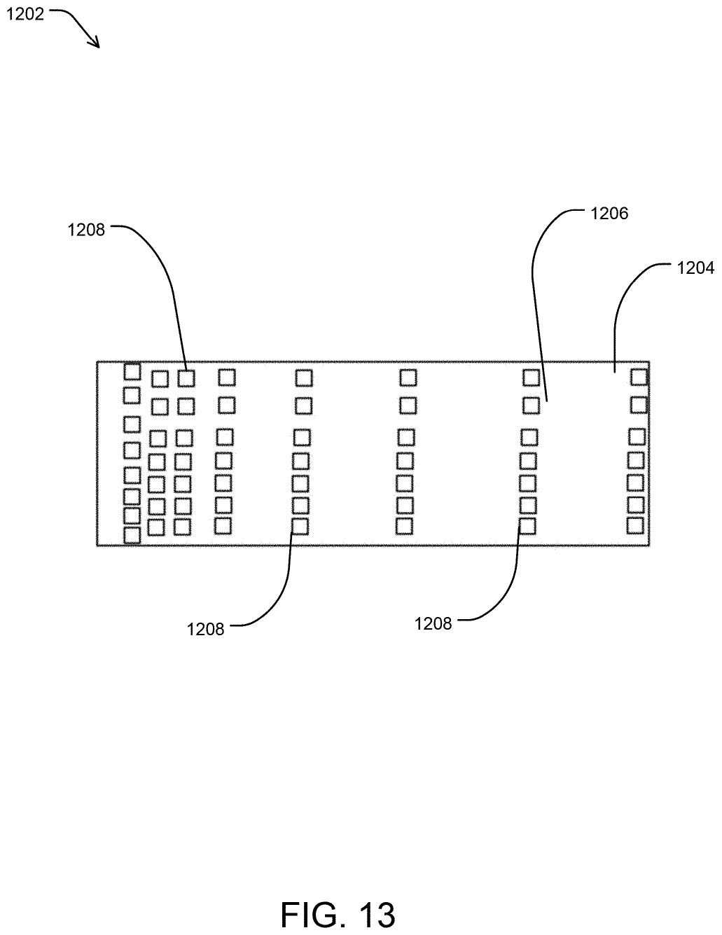

FIG. 12 illustrates a perspective view of an object 1202. FIG. 13 illustrates a side view of the object 1202. In the illustrated embodiment, the object 1202 also has a rectangular prism shape, and includes at least one surface 1204 that corresponds to a tracked body 1206 including surface features 1208. The surface features 1208 may be optimized and placed more densely in areas of desired higher resolution calculations. The specific locations of surface features 1208 can be optimized based on calculations specific to the method of manipulation to create the most noticeable differences upon manipulation. Within specific areas of interest on an object 1202 that contain more importance, higher densities of surface features 1208 may be utilized to determine results with a higher degree of accuracy. The surface features 1208 can also be placed such that gradient patterns are used in the tracking recognition process. The surface features 1208 may be dense or sparse and these features can be utilized in system calculations.

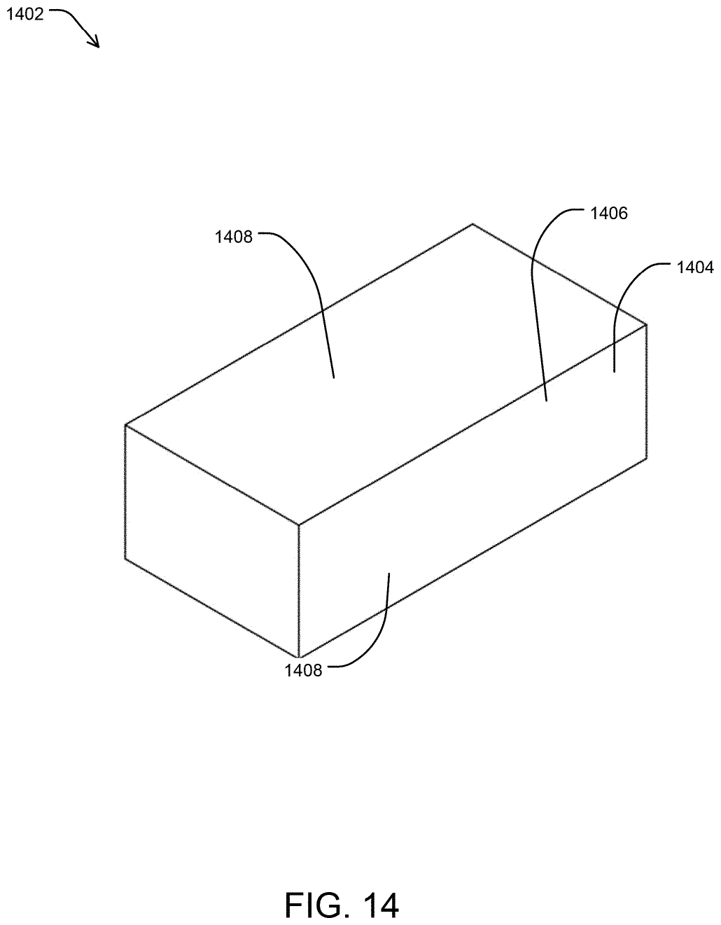

FIG. 14 illustrates a perspective view of an object 1402. In the illustrated embodiment, the object 1402 also has a rectangular prism shape, and includes at least one surface 1404 that corresponds to a tracked body 1406 including surface features 1408. The surface features 1408 may be innate to the object 1402 itself, meaning the object 1402 may contain trackable features that replace the need for printing additional surface features onto the object 1402. The surface features 1408 may also be initially invisible, and only become visible upon loading. One example of this is a thermochromic material that changes color when exposed to various levels of heat. The surface features 1408 may also be classified as edges or corners of the object 1402.

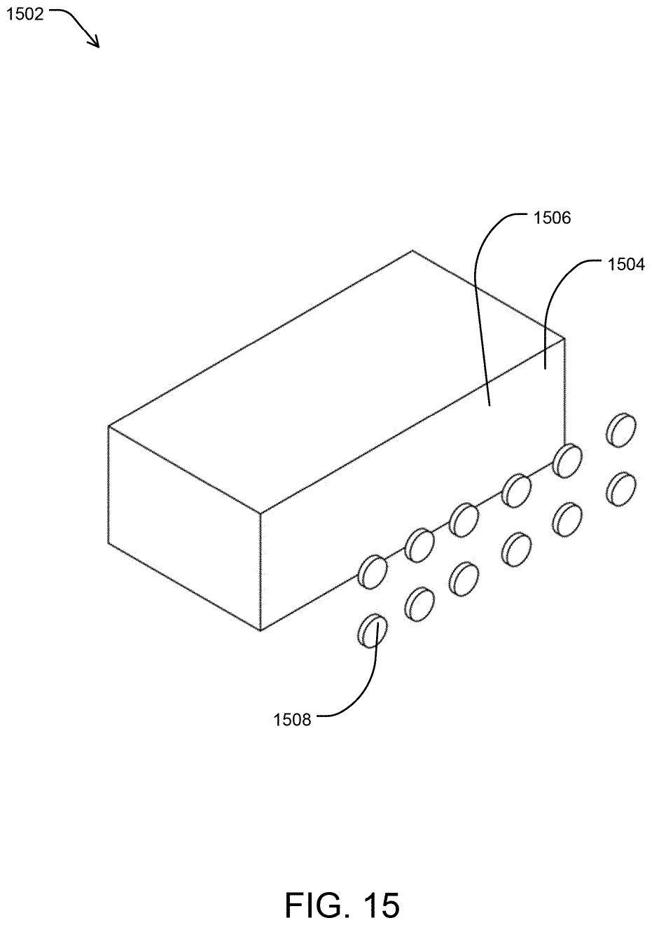

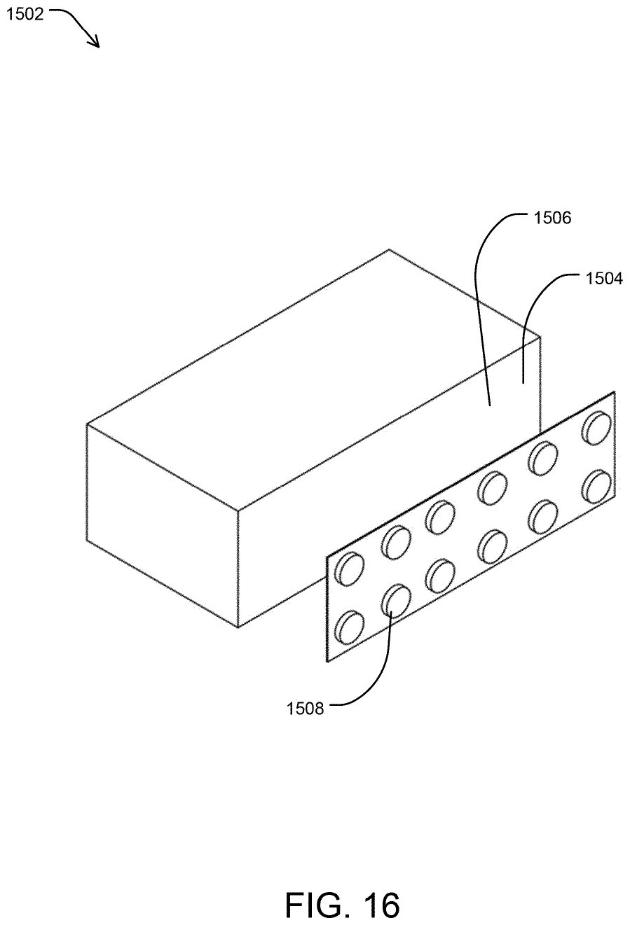

FIG. 15 illustrates a perspective view of an object 1502. FIG. 16 illustrates a perspective view of the object 1502. In the illustrated embodiment, the object 1502 also has a rectangular prism shape, and includes at least one surface 1504 that corresponds to a tracked body 1506 including surface features 1508. The surface features 1508 may be manufactured or produced. The surface features 1508 may be printed directly onto the object 1502. The surface features 1508 can be stuck onto the object 1502 temporarily or permanently using adhesive or other means of attachment. The surface features 1508 could also include markings from a pen or another surface mark. The surface features 1508 could be advised to be placed in certain orientations or could be customized and calibrated with the system. These surface features 1508 may be added as a set, or as individual markings.

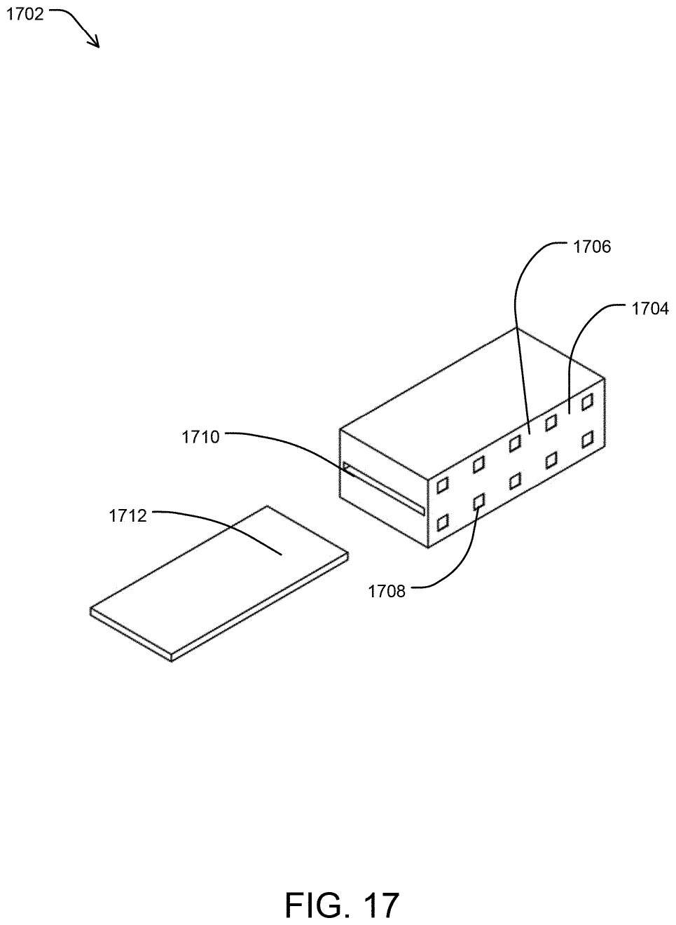

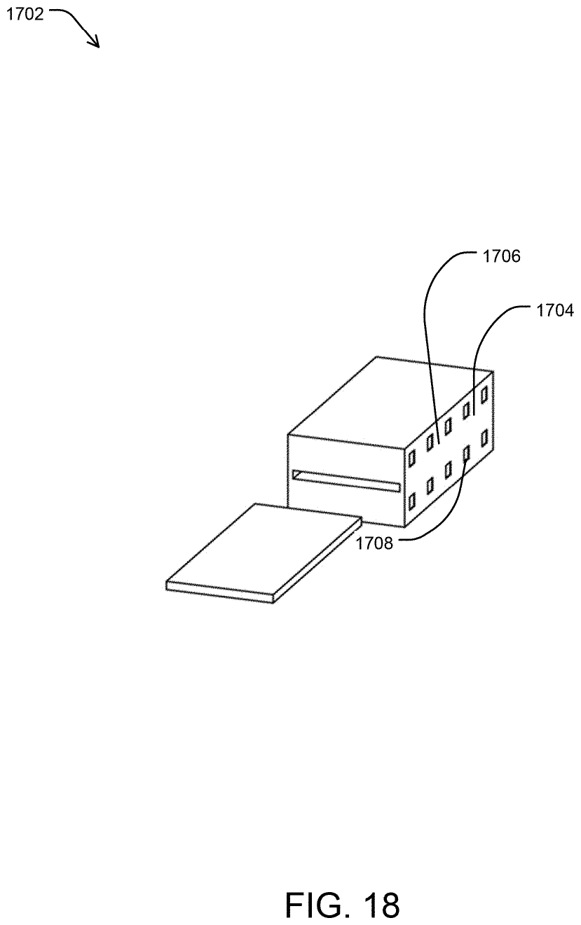

FIG. 17 illustrates a perspective view of an object 1702. FIG. 18 illustrates a perspective view of the object 1702. In the illustrated embodiment, the object 1702 also has a rectangular prism shape, and includes at least one surface 1704 that corresponds to a tracked body 1706 including surface features 1708. Properties of the object 1702 may be altered or changed with mechanisms such as the addition of higher modulus materials to the interior of the object 1702. For example, the object 1702 may include a hole or slot 1710 that receives a material 1712 therein. The process of altering the object 1702 may alter any material property of the overall object, such as density, stiffness, modulus of elasticity, etc. The alteration may be helpful in testing multiple different configurations of the object 1702 while allowing the user to only need one object 1702.

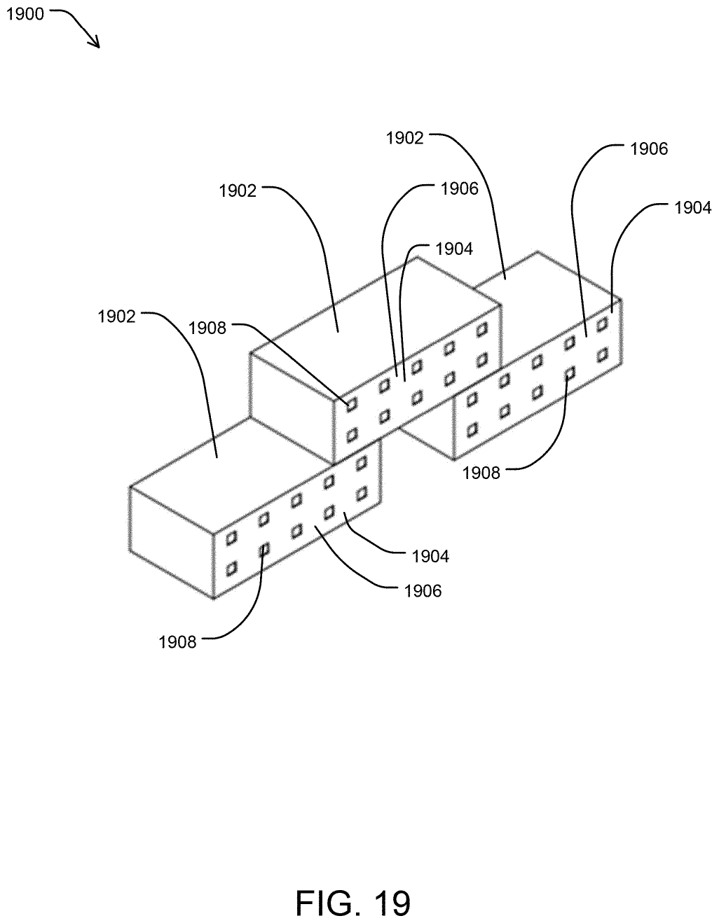

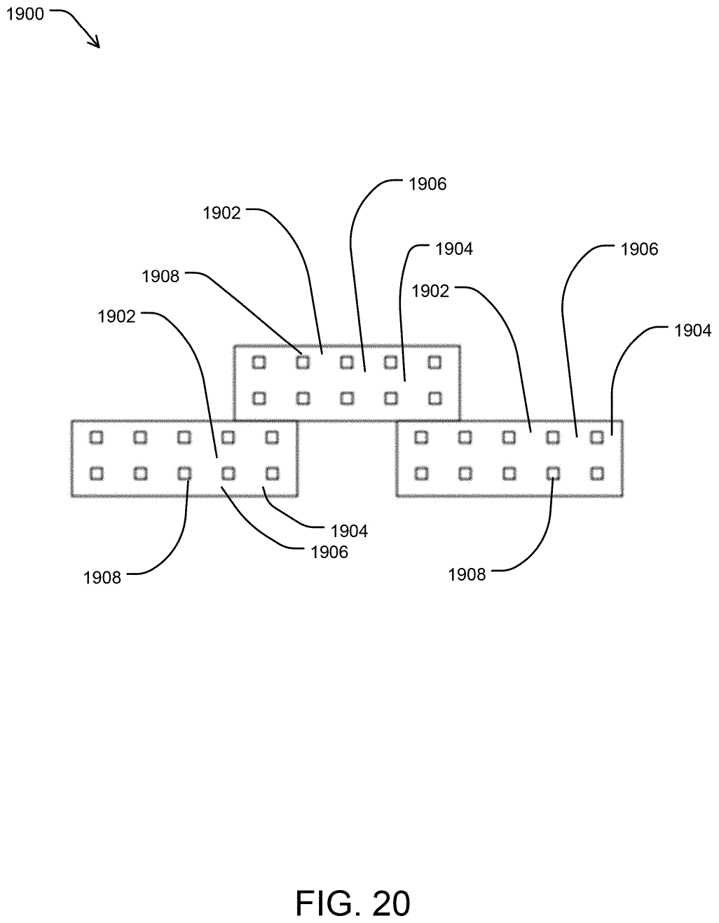

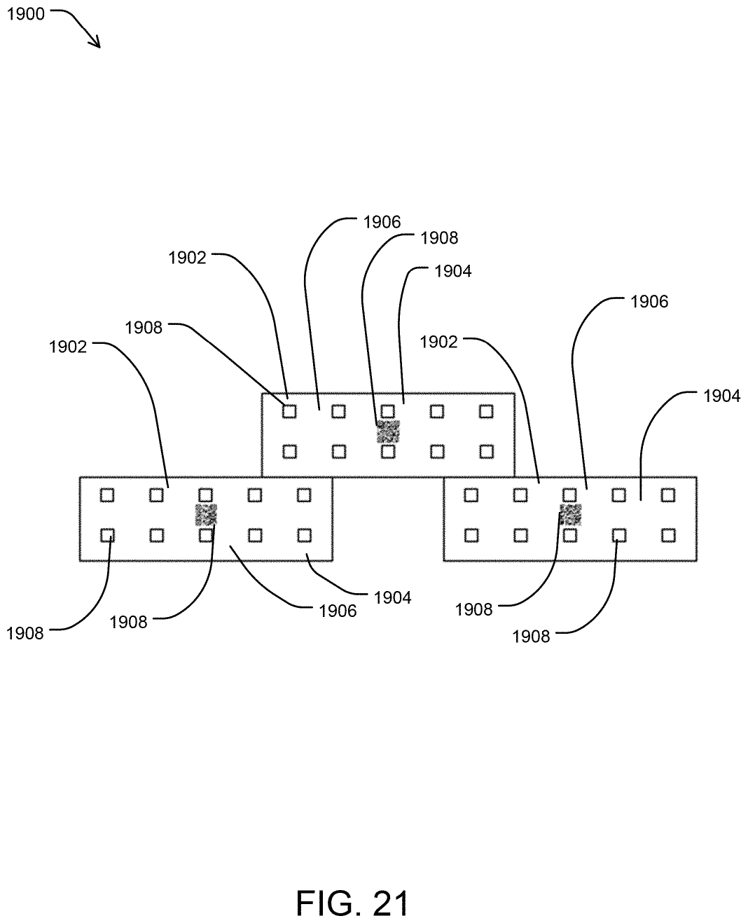

FIG. 19 illustrates a perspective view of a system 1900 of objects 1902. FIG. 20 illustrates a side view of the system 1900 of objects 1902. FIG. 21 illustrates another side view of the system 1900 of objects 1902. In the illustrated embodiment, each object 1902 also has a rectangular prism shape, and includes at least one surface 1904 that corresponds to a tracked body 1906 including surface features 1908. In the illustrated embodiment, the system 1900 includes a plurality of objects 1902. Specifically, in the illustrated embodiment, the system includes three objects 1902. In alternative embodiments, the system 1900 may include two, three, or more than three objects 1902. The objects 1902 may be used in combination with other objects 1902. The system 1900 may include multiple of the same objects 1902 with the same surface features 1908. The objects 1902 or the surface features 1908 may also vary when used in conjunction with one another. Variations in color may be used to differentiate the objects 1902. Multiple objects 1902 can be useful when modeling a system, or when building an overall structure that is not represented by one object 1902. The surface features 1908 have the same capabilities and behavior in this configuration as they do when only a singular object 1902 is used. The objects 1902 may use surface features 1908 to help identify and register the objects 1902 in multi-object combinations. The surface features 1908 may include a more complex and unique surface feature on each, such as a QR code. QR codes allow for the tracking of each object 1902 to function using the same process, while uniquely identifying the individual objects 1902.

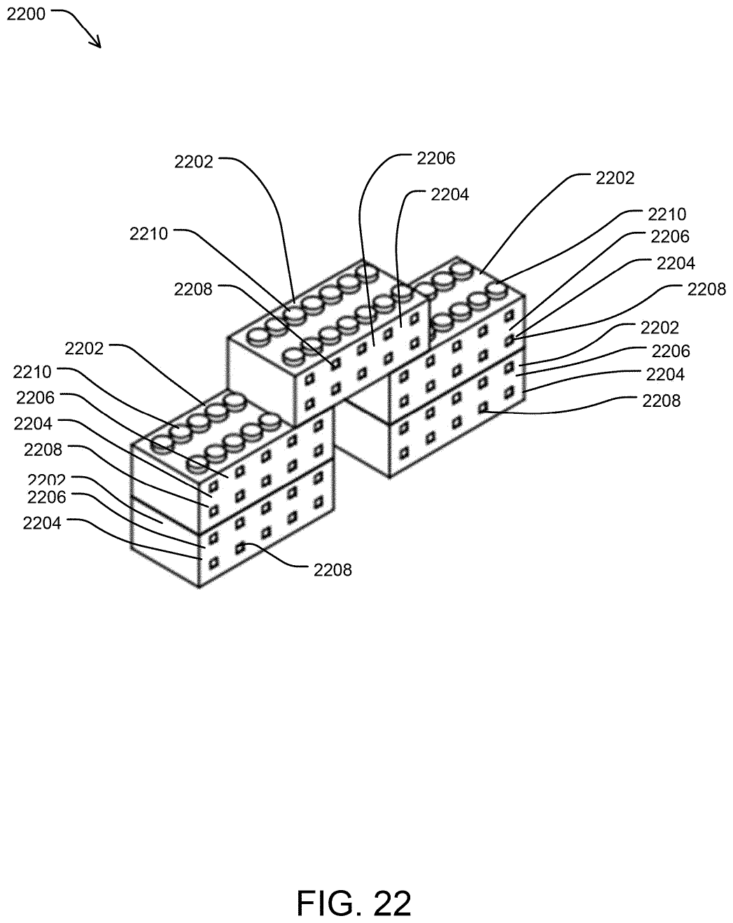

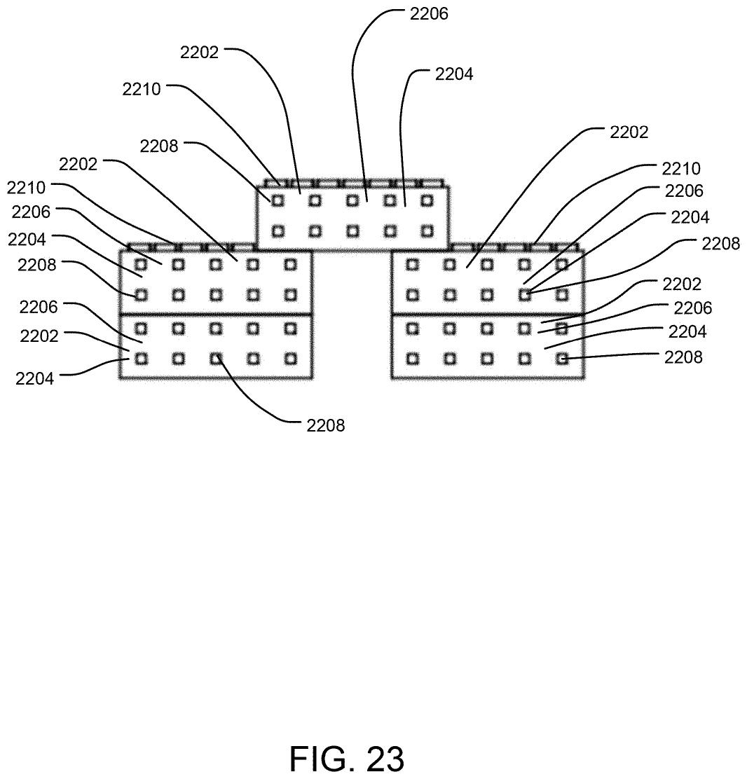

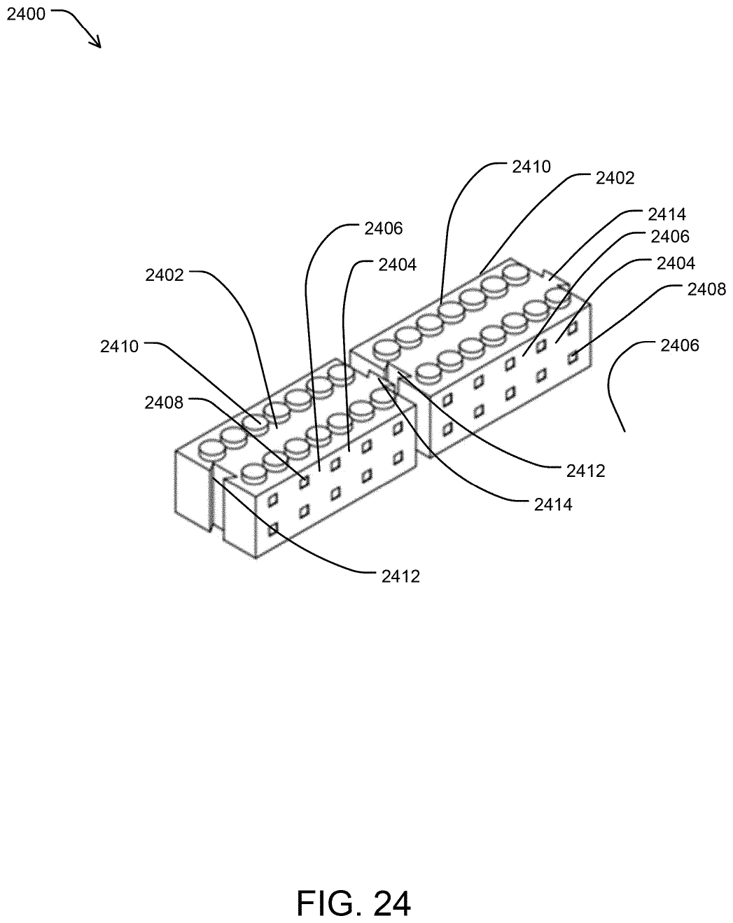

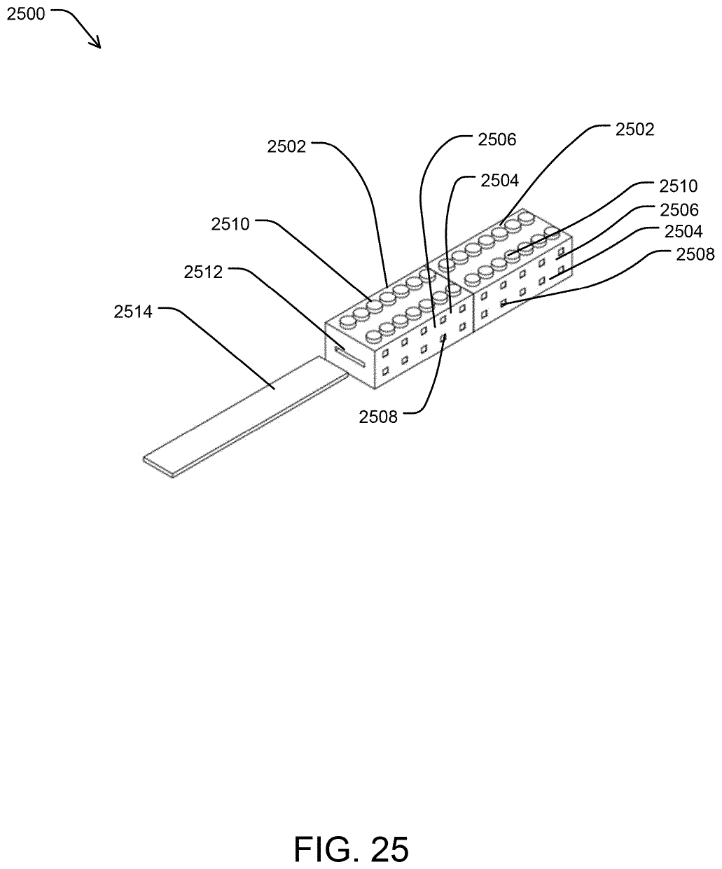

FIG. 22 illustrates a perspective view of a system 2200 of objects 2202. FIG. 23 illustrates a side view of the system 2200 of objects 2202. FIG. 24 illustrates a perspective view of a system 2400 of objects 2402. FIG. 25 illustrates a perspective view of a system 2500 of objects 2502. In the illustrated embodiment, each object 2202, 2402, and 2502 also has a rectangular prism shape, and includes at least one surface 2204, 2404, and 2504 that corresponds to a tracked body 2206, 2406, and 2406 including surface features 2208, 2408, and 2508. In the illustrated embodiment, each object 2202, 2402, and 2502 includes at least one connector 2210, 2410, and 2510 configured to connect the objects 2202, 2402, and 2502 together. In the embodiment illustrated in FIGS. 22-25, each object 2202, 2402, and 2502 includes at least one interlocking connector 2210, 2410, and 2510 positioned on one of the at least one surfaces 2204, 2404, and 2504 and a receptacle (not shown) positioned on another of the at least one surfaces 2204, 2404, and 2504 for receiving the interlocking connectors 2210, 2410, and 2510 on another of the at least one surfaces 2204, 2404, and 2504. The interlocking connectors 2210, 2410, and 2510 enable the objects 2202, 2402, and 2502 to remain together as the user manipulates the systems 2200, 2400, and 2500. Additionally, the objects 2402 may also include a slot 2412 on another of the at least one surfaces 2204, 2404, and 2504 and a protrusion 2414 on another of the at least one surfaces 2204, 2404, and 2504. The slot 2412 is configured to receive the protrusion 2414 to enable the objects 2402 to remain together as the user manipulates the system 2400. Additionally, the objects 2502 may include a hole or slot 2512 that receives a material 2512 therein. The material 2514 may extend across multiple objects 2502 through multiple slots 2512 as the user manipulates the system 2500.

The objects 2202, 2402, and 2502 may use the connectors 2210, 2410, and 2510 or other forms of interaction to form temporary or permanent unions for the purpose of multi-object interaction. The objects 2202, 2402, and 2502 may have a variety of features allowing for the connectors 2210, 2410, and 2510 to be utilized such as clasps, studs, slots, and more. Some connectors 2210, 2410, and 2510 may simultaneously combine two objects 2202, 2402, and 2502 and change their individual properties. These connectors can be used to combine two objects 2202, 2402, and 2502, or many objects 2202, 2402, and 2502 to create a larger structure or system that is not accurately modeled by one object 2202, 2402, and 2502.

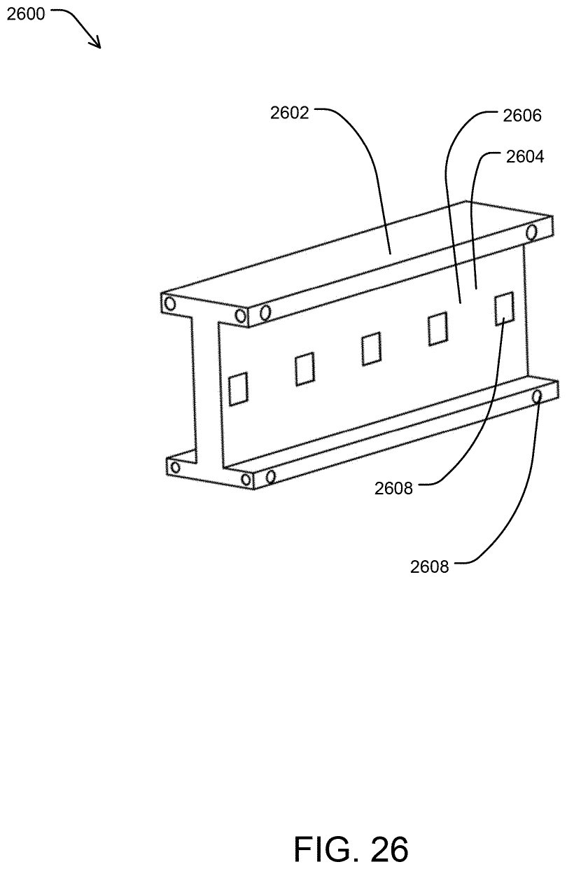

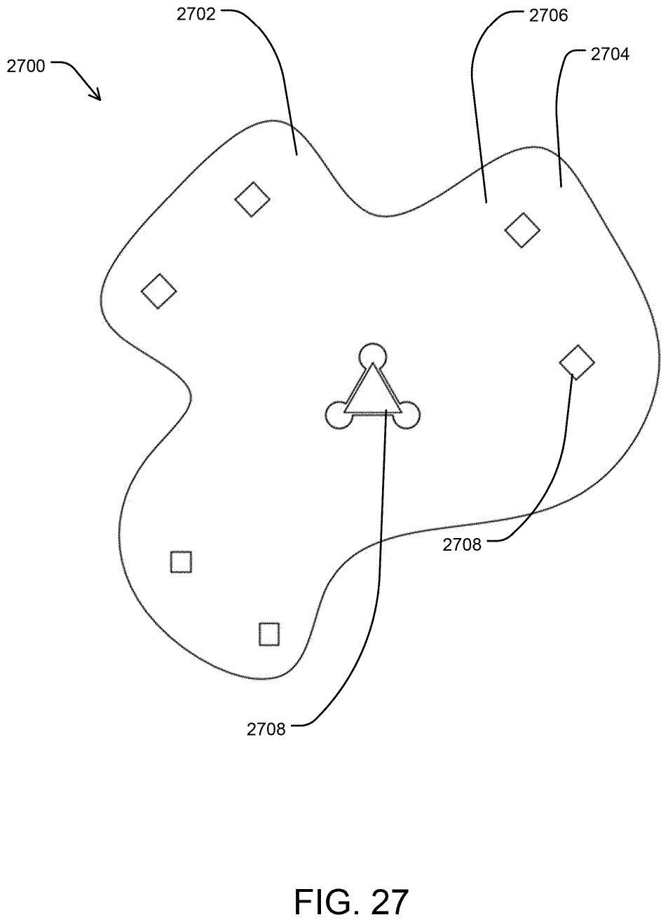

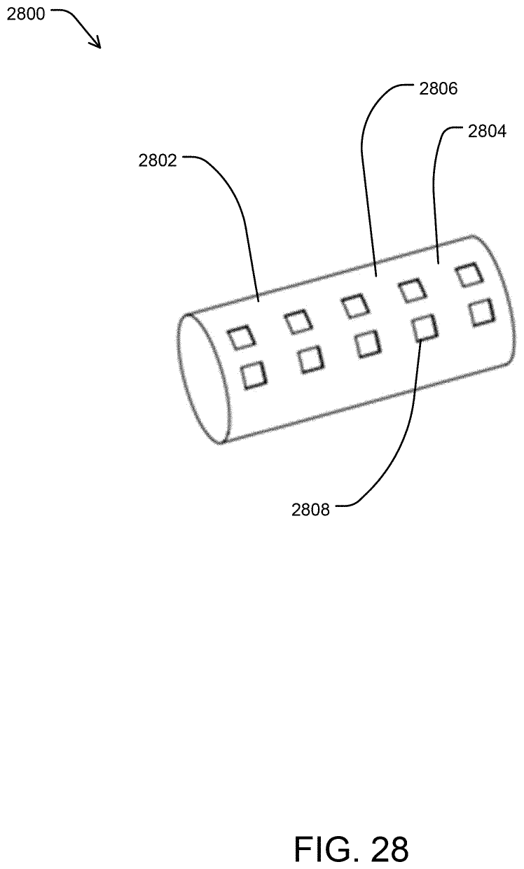

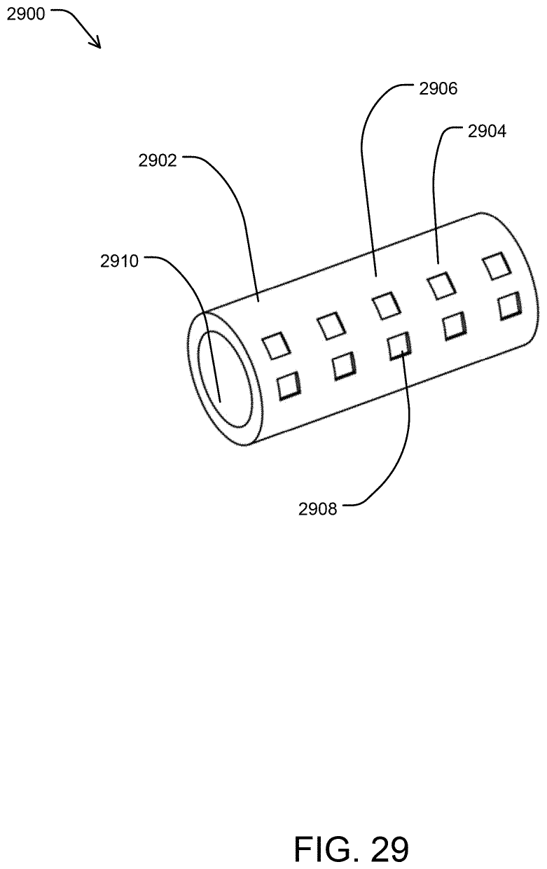

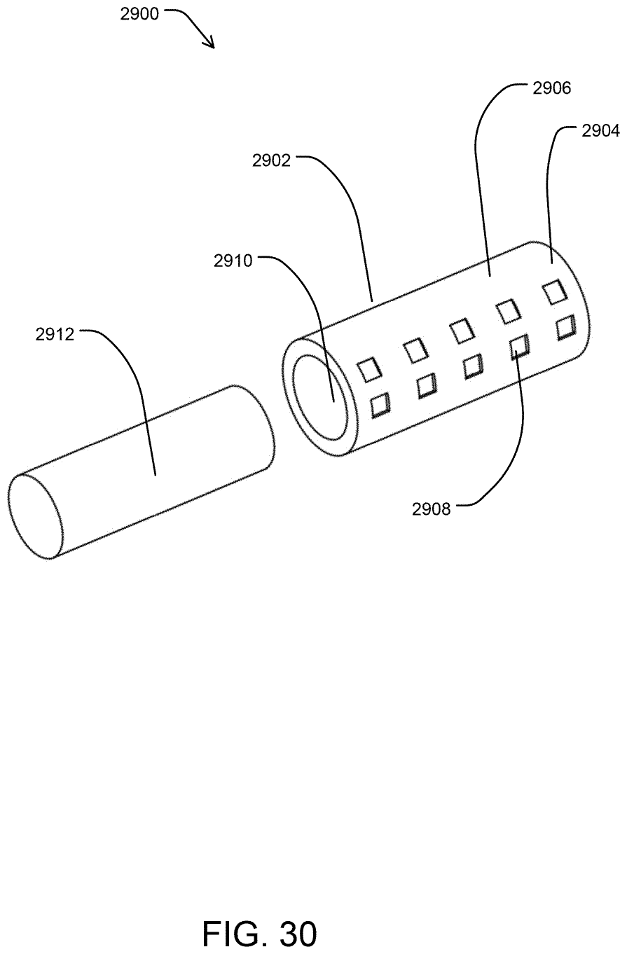

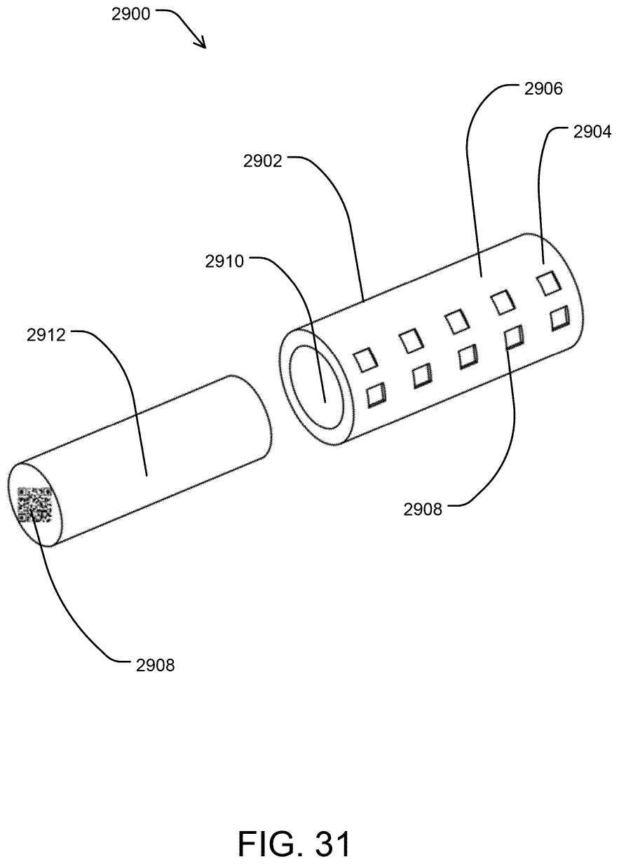

FIG. 26 illustrates a perspective view of an object 2602. FIG. 27 illustrates a perspective view of an object 2702. FIG. 28 illustrates a perspective view of an object 2802. FIG. 29 illustrates a perspective view of an object 2902. FIG. 30 illustrates another perspective view of the object 2902. FIG. 31 illustrates another perspective view of the object 2902. In the illustrated embodiment, each object 2602, 2702, 2802, and 2902 includes at least one surface 2604, 2704, 2804, and 2904 that corresponds to a tracked body 2606, 2706, 2806, and 2906 including surface features 2608, 2708, 2808, and 2908. The shape of the objects 2602, 2702, 2802, and 2902 may be any shape, and the surface features 2608, 2708, 2808, and 2908 may appear on any surface 2604, 2704, 2804, and 2904. In the embodiment illustrated in FIG. 26, the object 2602 includes an I-beam shape. Additional geometries can include any other 3-dimensional objects. The surface features 2608, 2708, 2808, and 2908 are shown on multiple surfaces 2604, 2704, 2804, and 2904, and multiple shapes and sizes are used for different purposes. The object 2602 may contain surface features 2608, 2708, 2808, and 2908 on any of its' surfaces 2604, 2704, 2804, and 2904. Additionally, as shown in FIG. 27, the object 2702 can be of any size or shape and have surface features 2708 located anywhere on the object 2702. This is not limited to specific geometries and can be any three-dimensional shape. This can also include any two-dimensional sheet of material. The surface features 2708 may be oriented in any direction on the object 2702. Additionally, as shown in FIG. 28, the object 2802 may be a cylinder. Moreover, as shown in FIGS. 29-31, the object 2902 may be a tube defining a cylindrical cavity 2910 therein. In some embodiments, the cylindrical cavity 2910 is configured to receive a material 2912 therein. The material 2912 may include additional surface markings 2908 for the purpose of identification, registration, and/or calibration. The material 2912 may also change the physical properties and behavior of the overall object 2902, such as the density, stiffness, or weight.

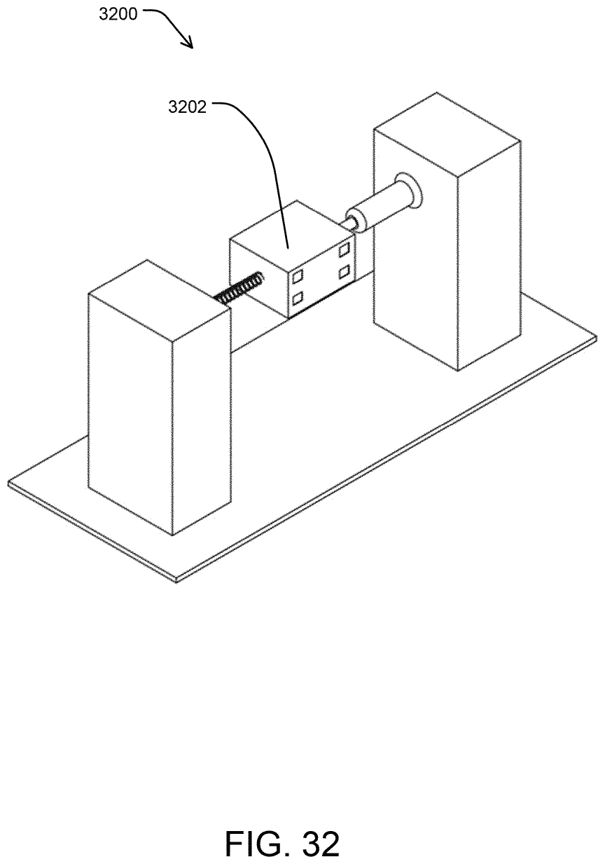

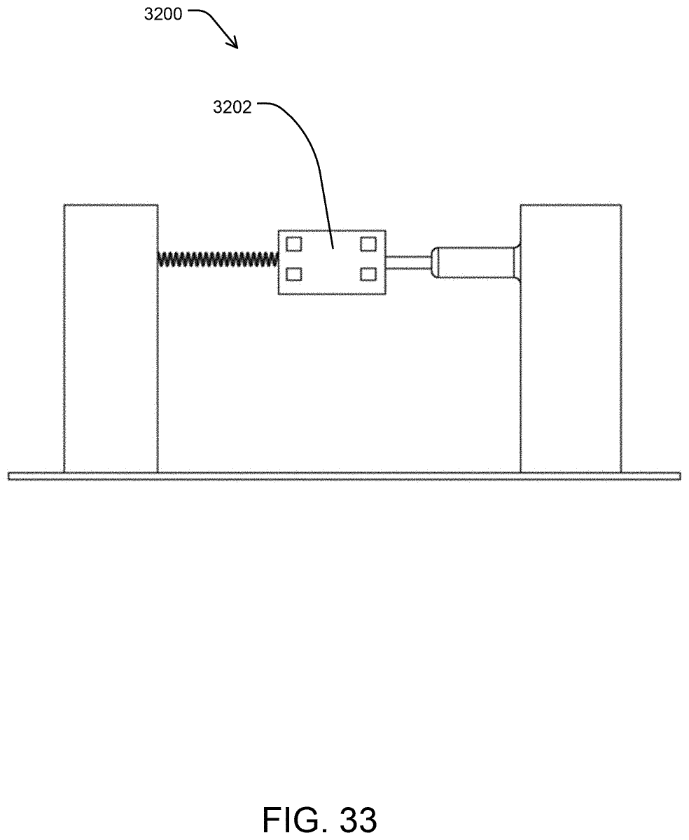

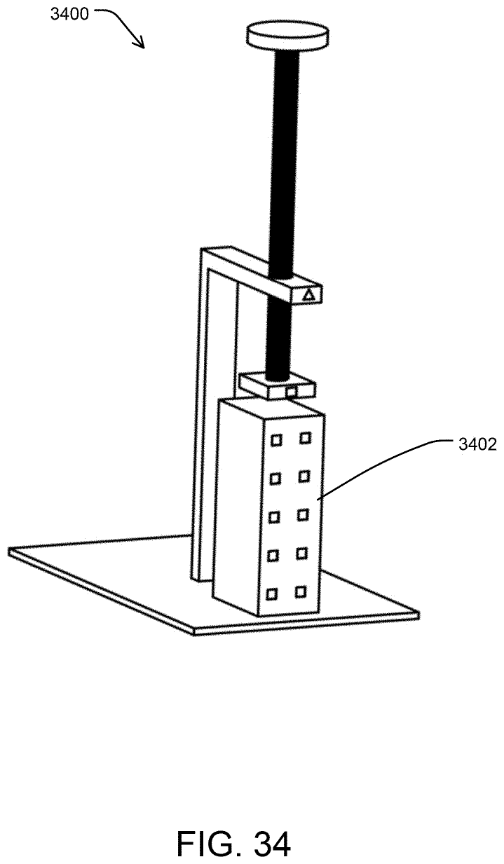

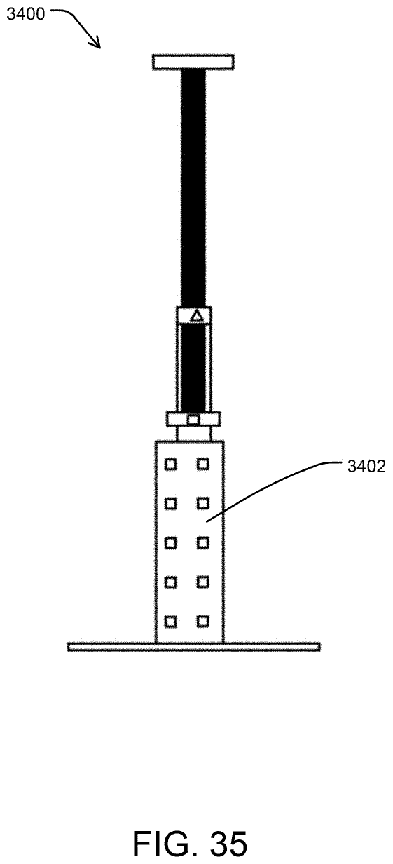

FIG. 32 is a perspective view of a manipulation device 3200 including an object 3202. FIG. 33 is a side view of the manipulation device 3200. FIG. 34 is a perspective view of a manipulation device 3400 including an object 3202. FIG. 35 is a side view of the manipulation device 3400. The manipulation devices 3200 and 3400 may impart forces or changes on the objects 3202 and 3402. The manipulation device 320 includes a mass spring damper system that imparts a force on the object 3202 and the behavior of the mass spring damper system is measured to determine properties of the object 3202. In other cases, the objects 3202 and 3402 may be used to measure the behavior of other manipulation devices 3200 and 3400. The manipulation devices 3200 and 3400 may interact with the objects 3202 and 3402 by applying force or translation to the objects 3202 and 3402. The manipulation devices 3200 and 3400 may also contain surface markings for the purpose of creating a system of objects. The manipulation devices 3200 and 3400 can both be tracked separately or can be analyzed jointly.

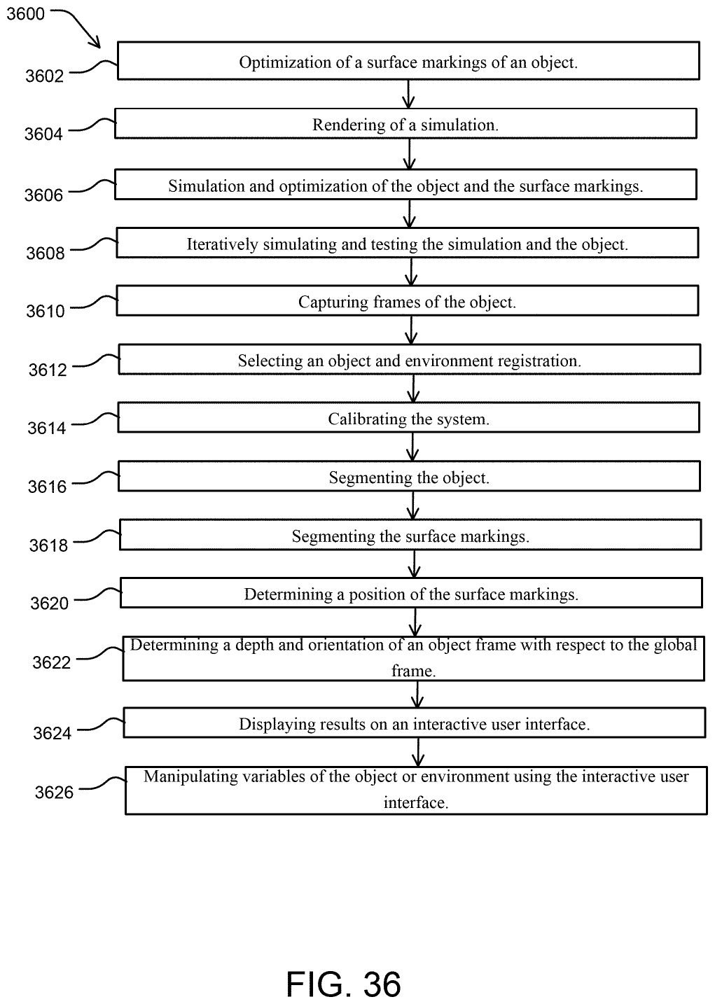

FIG. 36 illustrates a flow diagram of a method 3600 of detecting properties of an object. The method 3600 includes optimization 3602 of the surface markings of objects that can be utilized to gain better system performance. Optimization is not always necessary for all implementations of the system. Optimization 3602 includes simulating the tracked environment of the object to design the surface marking variables. The surface marking variables can be any of the following, but not limited to, spacing, shape, color, texture, location, orientation with other markings and size. The tracked environment includes anticipated loading, desired resolution, object movement, orientation of the object, location with respect to the camera, and background of the video.

The method 3600 may also include rendering of the simulation. The simulation is rendered given the object geometry and the tracked environment. The simulation takes into account the movement of the object as well as the anticipated deformation of the object based on the loading. An example of this would be a rectangular object in three-point bending. The deformation of the object can be predicted with mechanics equations such as Euler-Bernoulli bending theory or through the use of finite element method. The object is then projected onto a 2D plane reflective of the camera that would visualize these objects. Initialization of surface markings can come from random initialization, user defined, or an initial test of all points on the object projected onto the 2D plane to determine points of maximum or minimum movement.

The method 3600 may also include simulation and optimization 3606 of the object and the surface markings for the desired measured outputs. After initialization, the method of designing surface markings involves the simulation of the object and performing an optimization of surface markings for the desired measured outputs. The program simulates changes in surface marking configuration, loading or movement of the theoretical object, and projects the outcomes of the camera view. The analysis software is then used to return results of the measurement system for the desired loading or movement scenario. An optimizer for the surface marking control variables is implemented in order to achieve an optimal configuration for the desired conditions. Optimization of these configurations can be used, but are not limited to, Gradient Decent optimization or Newton-Raphson method. The values optimization may be configured to do any of the following or a combination of the following, minimize errors at non-perpendicular camera angles, minimize environmental interference with object tracking, maximize resolution of measured values, maximize or minimize surface marking deformation, maximize or minimize surface marking movement, minimize calculation and tracking performance (time of segmentation and calculation of measured variables).

The method 3600 may also include iteratively simulating and testing 3608 the simulation and the object. An iterative process of simulation and testing can be done to include multiple variations in tracked environment and surface markings. Changes in tracked environment can be implemented to minimize tracking error in different configurations. Additionally, multiple loading or motion environments can be tested to optimize surface markings for different configurations. The optimization of surface markings can be in combination or separate from each tracked environment. A set of surface markings can be optimized for a specific tracked environment and ignored for other loading environments or fused for satisfactory measured value for multiple loading environments.

The method 3600 may also include capturing 3610 frames of the object. The camera input for the system captures frames of the tracking object. The camera input can be one or multiple sensors. The sensors can be embedded in other objects, such as laptops, cell phones, tablets, AR VR headsets, digital displays, standalone cameras, or any other system with camera sensors. The camera sensor may capture color, non-colored image, IR, LiDAR, or any form of optical sensor capable of capturing the tracking object and surface features.

The method 3600 may also include selecting 3612 an object and environment registration. Object and environment registration is the means of communicating the object and surface features present, as well as the action being taken on, or by, the object. This process can be manual, such as the user using a user interface to select the color and shape of the tracked beam, and the color, shape, location, and number of the surface features. Automated registration can also take place separate or in conjunction with manual registration. Automatic registration utilizes the camera input to recognize the object via analytical heuristics methods or object recognition via machine learning. Object and environment registration can be aided by unique surface features, shape of the object, multiple objects in the scene, QR codes, or action taken on/by the object. These methods of registration can also encode environmental registration, such as the desired loading type for an object, desired movement of an object, the material properties of an object, the physical properties of an object, or the interaction one object has on another object.

One example of this registration process is a user interfacing with a software to select a green rectangular prism as their object. The system may know characteristics of this object selection such as the rectangular prism is 4 inches long and has surface markings that consist of 8 red squares laid out in two horizontal lines. The user may also specify that they will be twisting this object, to communicate the method of manipulation. Another example of this registration would be a QR code printed on the object which communicates each of those details, and instructions for the user to twist the object.

For cases where surface markings may have been placed by the user, object registration is necessary to determine the location of surface markings with respect to the object. The user may be instructed to perform a number of tasks, as well as manipulate the object in multiple views and loading environments in order to characterize this object.

The method 3600 may also include calibrating 3614 the system. Calibration of the system may have manual and automatic components. Calibration comes in the form of object parameter calibration and camera input calibration. Camera input calibration seeks to optimize camera settings in order to minimize tracking error and maximize object segmentation. These parameters might be manipulated on the camera itself, or in postprocessing of the images. Changes in brightness, saturation, focal distance, hue, value, are examples of camera settings that might be manipulated in order to optimize the system. This calibration procedure may take place at the initialization of tracking, or through a continuous function throughout the tracking process. The user may provide input to the calibration in order to optimize the system for specific environments.

Calibration of the objects may include specific movements in front of the camera system, specific loading of the object, or placement of the object next to a reference object in the environment. Calibration of the object maybe necessary for the determination of material properties, determination of the position size or shape over the object, this may also allow for proper ranging of the object and its deformation with the specific camera system.

The method 3600 may also include segmenting 3616 the object. Object(s) segmentation is the process of isolating the object(s) from its' outside environment. Frame(s) are taken from the camera system in which the object appears in the global environment. Localization and segmentation of the object is performed in order to isolate the object from the scene and create both a global reference frame and local object reference frame for calculations to occur.

Deep learning techniques, such as convolutional neural networks, can be used in the segmentation of the object from the environment. In combination with or separate from machine learning methods, classical techniques for object segmentation can also be utilized such as thresholding, edge detection, motion segmentation, template matching, and shape analysis. Post processing of the frame may be necessary to improve tracking such as frame transformations, de-noising, color correction, color segmentation, color conversion, resizing, image smoothing, blurring, Gaussian Filters, ranging, normalization, or other post processing steps to improve segmentation.

The method 3600 also includes segmenting 3618 the surface markings. Surface marking segmentation serves to locate and isolate specific regions of the surface and map them to the local object reference frame. This is often performed once the object has been segmented. This can be done using the segmentations methods previously described herein.

The method 3600 also includes determining 3620 a position of the surface markings. After segmentation of the surface markings and mapping to the local reference frame, surface marking positions are determined. Calculations to determine the size, shape, and orientation of the individual surface markings may be done. Next, the relation from one or more surface markings to other surface markings or groups of surface markings may be calculated. The distances and orientation of these surface markings or groups of surface markings may be utilized in the determination of the movement and deformation of the object. The orientation of the surface markings, such as the position or angle between sets of surface markings may be compared to the original calibrated or registered object orientations and locations. The comparison of the original orientations may be utilized in the determination of deformation or movement of the object. Approaches to analyze these changes may be calculated through know geometries relations, classic mechanics calculations, finite element methods, as well as modeling and fitting of the object data including machine learning.

Inputs from the knowledge of the environment registration, such as the loading condition can be utilized to further refine the analysis of these points. In addition, not all surface markings may be utilized for all conditions. Certain surface markings or sets of certain surface markings may be utilized as references to other sets of surface markings in order to compensate for changes in depth, angle, or orientation of the beam with respect to the frame capture. These relations can also be utilized to determine the forces and motion of the objects. Information from the initial optimization of the surface markings, as well as the calibration steps are critical in analysis of the surface markings to derive the desired measures of the system. In addition, this segmentation and analysis of the object can be utilized in these calculations as well. The orientation, size, shape, and motion of the local beam reference frame in reference to the global frame may be utilized in calculation of the desired metrics.

The method 3600 also includes determining 3622 a depth and orientation of an object frame with respect to the global frame. The determination of the depth and orientation of the object frame with respect to the global frame may be necessary to account for distortions in measures when projected on a 2D plane, such as a digital camera. These measures are used in the adjustment of measures taken from the segmented surface marking relations as well as the object measures. The determination of the angle and depth may be extracted from shape, position, and orientation measures of the surface markings and the object. In addition, independent techniques such as depth from motion, stereo vision, depth from focus, dual pixel autofocus, IR, LiDAR, and machine learning depth techniques may be used to determine depth and orientation.

From these measures the desired tracked variables can be determined. These measures can then be relayed to the user and/or stored in memory. The measures can be used to create graphics, charts, and other representations of the data. The display of these visualizations may be on a separate area or overlayed on the frame of the camera image. These frames can be distorted or manipulated for further visualization. Objects may be overlayed or placed in the scene for the guidance of the user or for display purposes. These objects may be generated or real objects. The visualization may take place on the device that contains the camera device or on a separate device. The visualization may be live or a recording or capture of the object. The display of the visualization may come in the form of audio, video, photos, plots, text, figures, table, augmented reality, virtual reality, or other forms of data representation.

The method 3600 also includes displaying 3624 results on an interactive user interface and manipulating 3626 variables of the object or environment using the interactive user interface. The interactive user interface allows for the user to manipulate variables of the object or environment. For example, the interface may allow the user to manually specify what the object is and what types of loading are occurring to the object. This interactive user interface allows for the selection of different information to be displayed, and the user can determine what calculations and plots are shown as they manipulate the object. The interactive user interface allows for the changing of specific variables, to simulate a different property of the object. For example, the user can change the material properties (density, modulus of elasticity, weight) of the object within the user interface, and the calculations and outputs will change correspondingly. The user could also change the geometry of the object within the user interface, and the plots and calculations will change correspondingly to simulate how a different geometry would behave under the same loading conditions. One example is with a user manipulating a rectangular prism with a modulus of elasticity of 0.3, the calculations use this information to display the correct outputs on the plots. The plots will display a rectangular prism with those specified material properties. If the user specifies the object of interest is a “cylinder” and changes the modulus of elasticity to 0.2, the calculations will reflect the changes to geometry and physical properties. After solving for the load applied in the physical loading scenario, the system will apply this load to the specified cylinder with a modulus of elasticity of 0.2. This new data will be input to the calculations, and the outputs for plots will reflect these changes. In addition, other features of the interface may include guided tutorials, videos, equations, quizzes, or questions.

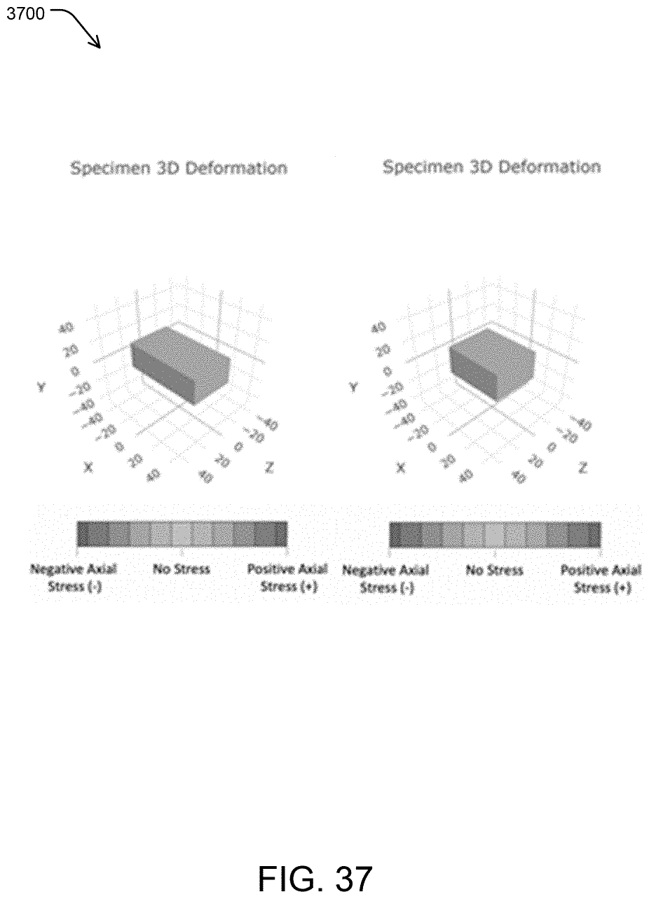

FIGS. 37-51 illustrate various graphical displays on the interactive user interface. For example. FIG. 37 illustrates plots 3700 generated of the objects described herein. The plots 3700 are generated from an object as it is loaded with an axial force. The square nodes on the object are tracked. Their positions within the camera view are then measured and calibrated. As the user compresses or expands the object in the axial direction (X Direction), this graph pulls displacement and stress calculations to display the current physical status of the object in the X, Y, and Z plane, as well as shades the plot a color to display the magnitude of stresses present within the object.

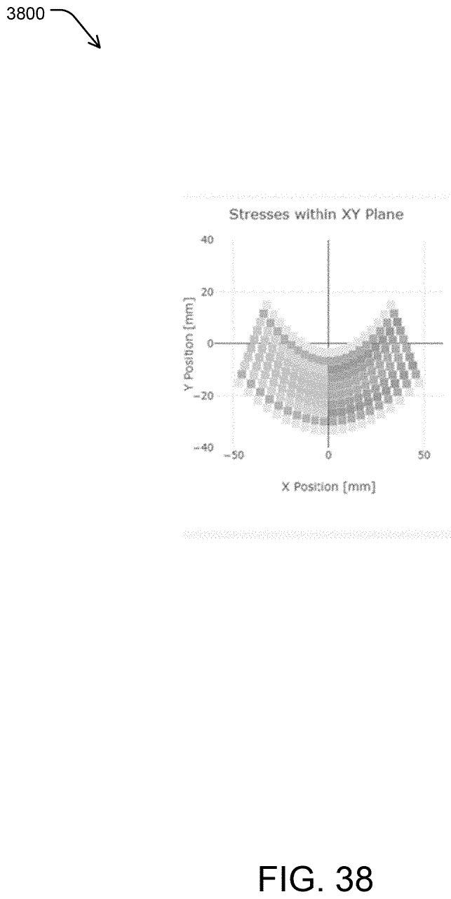

FIG. 38 illustrates a plot 3800 generated of the objects described herein. The plot 3800 is generated from the object with interlocking connectors as it is loaded with a transverse shear force. The square nodes on the object with interlocking connectors are tracked. Their positions within the camera view are then measured and calibrated. As the user applies a positive or negative transverse shear load to the object, the plot 3800 pulls displacement and stress calculations. The plot 3800 displays the position of the object in the XY plane, as well as displays via color the stresses within the object while under loading conditions.

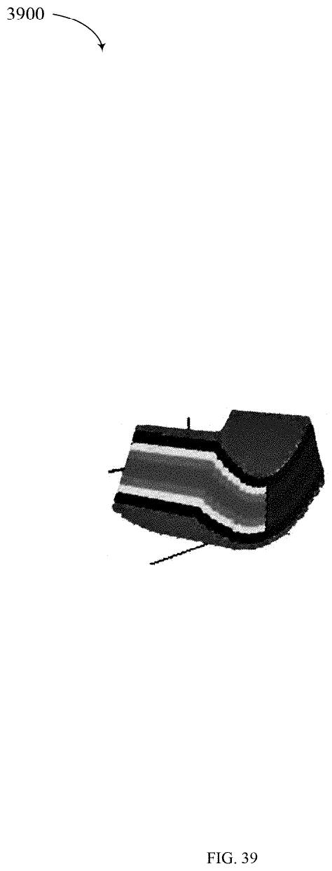

FIG. 39 illustrates a plot 3900 generated of the objects described herein. The plot 3900 is generated from the object with interlocking connectors as it is loaded with a transverse shear force. The square nodes on the object with interlocking connectors are tracked. Their positions within the camera view are then measured and calibrated. As the user applies a positive or negative transverse shear load to the object, the plot 3900 pulls displacement and stress calculations. The plot 3900 displays the position of the object in the XYZ plane, as well as displays via color the stresses within the object at each node shown on the 3D scatterplot.

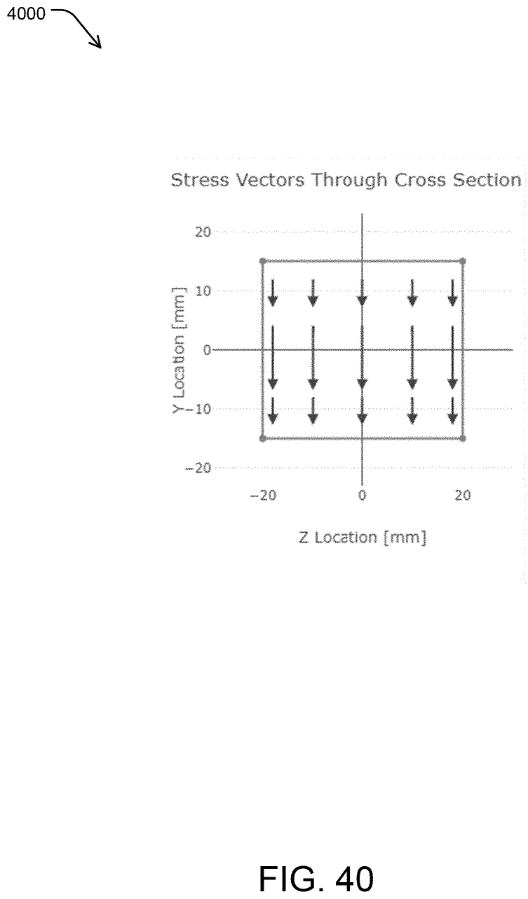

FIG. 40 illustrates a plot 4000 generated of the object(s) described herein. The plot 4000 is generated from the object with interlocking connectors as it is loaded with a transverse shear force. The square nodes on the object with interlocking connectors are tracked. Their positions within the camera view are then measured and calibrated. As the user applies a positive or negative transverse shear load to the object, the plot 4000 pulls displacement and stress calculations. The plot 4000 shows a cross-section view of the object and displays arrows of differing sizes, representing the magnitude of the stress vectors within the cross-section as the object is manipulated.

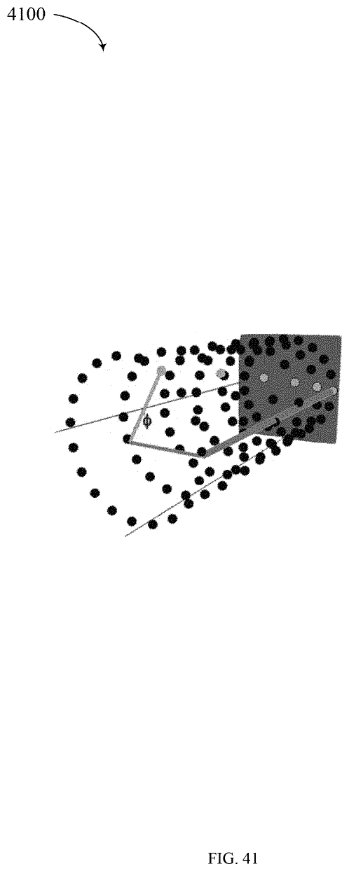

FIG. 41 illustrates a plot 4100 generated of the objects described herein. The plot 4100 is generated from the cylindrical object as it is loaded with a torque (twisting force). The square nodes on the cylindrical object are tracked. Their positions within the camera view are then measured and calibrated. As the user applies a torque to the cylindrical object (twists the object), this graph pulls displacement calculations to display the current physical status of the beam in the X, Y, and Z plane. More specifically, the plot 4100 displays the angle-of-twist of the object by showing how far the original points along a line within the X plane have displaced along the object.

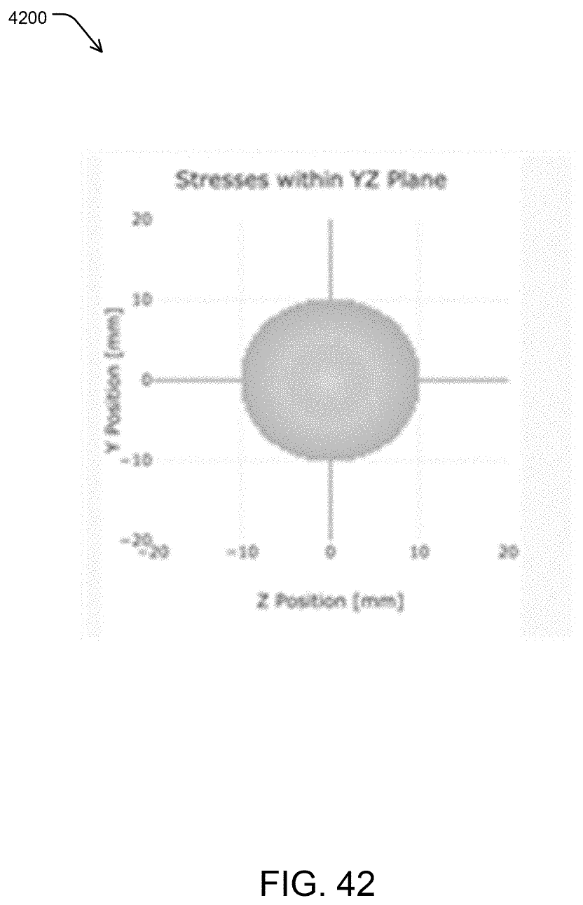

FIG. 42 illustrates a plot 4200 generated of the objects described herein. The plot 4200 is generated from the cylindrical object as it is loaded with a torque (twisting force). The square nodes on the cylindrical object are tracked. Their positions within the camera view are then measured and calibrated. As the user applies a torque to the object (twists the object), this graph pulls displacement and stress calculations to display the current physical status of the object in the YZ plane. The plot 4200 displays varying shades of color to represent the magnitude of the stress within the cross-section of the object as it is twisted.

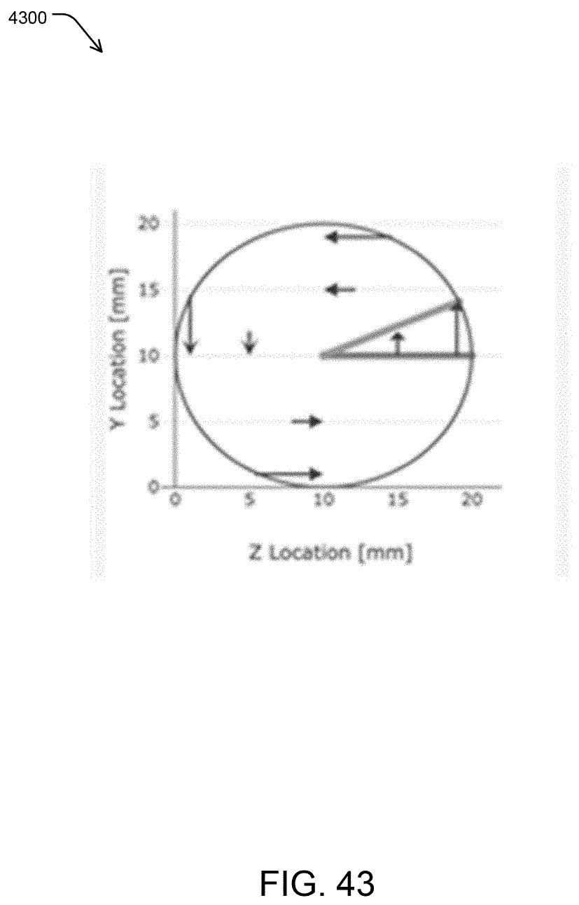

FIG. 43 illustrates a plot 4300 generated of the objects described herein. The plot 4300 is generated from the cylindrical object as it is loaded with a torque (twisting force). The square nodes on the cylindrical object are tracked. Their positions within the camera view are then measured and calibrated. As the user applies a torque to the object (twists the object), this graph pulls displacement and stress calculations to display the current physical status of the object in the YZ plane. Arrows of varying magnitude display the levels of strain within the cross-section of the object, and the angle-of-twist is displayed using two lines on the cross-sectional view. These calculations change as the object is twisted and manipulated.

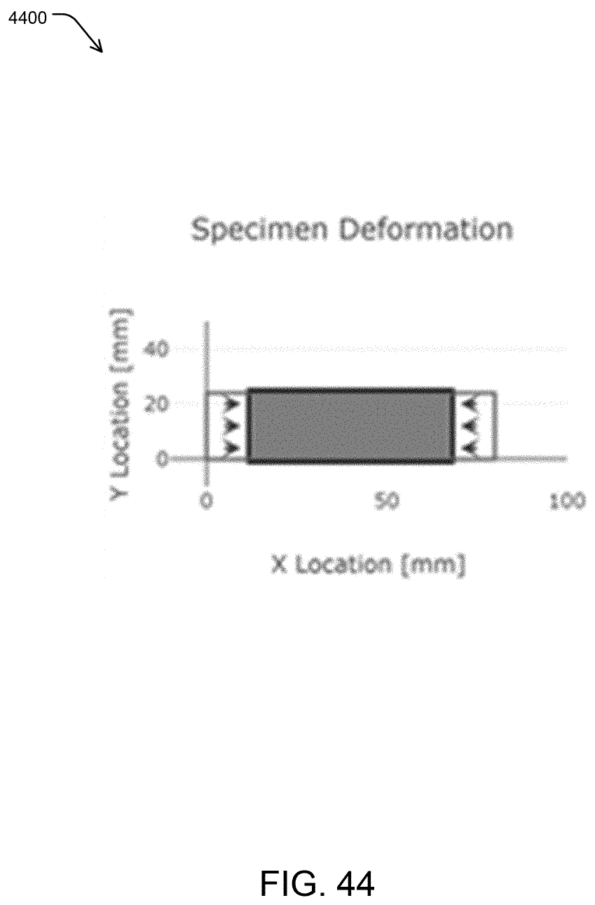

FIG. 44 illustrates a plot 4400 generated of the objects described herein. The plot 4400 is generated from the object with interlocking connectors as it is loaded with an axial force. The square nodes on the object with interlocking connectors are tracked. Their positions within the camera view are then measured and calibrated. As the user compresses or expands the object in the axial direction (X Direction), this graph pulls displacement and stress calculations to display the current physical status of the object in the XY plane, as well as shades the plot a color to display the magnitude of deformation present within the object. Poisson's ratio can also be observed as the non-loaded axis of the object also deforms.

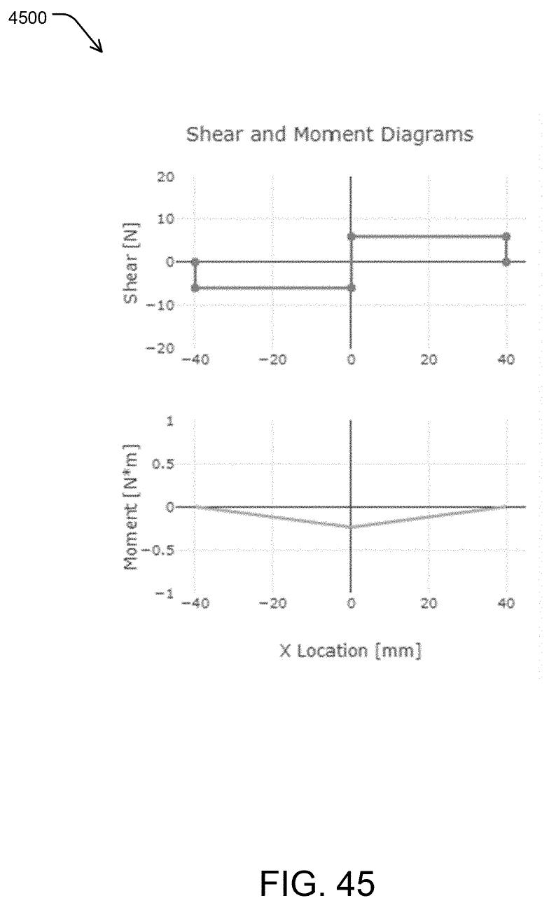

FIG. 45 illustrates a plot 4500 generated of the objects described herein. The plot 4500 is generated from the object with interlocking connectors as it is loaded with a bending force. The square nodes on the object with interlocking connectors are tracked. Their positions within the camera view are then measured and calibrated. As the user applies a positive or negative bending force to the object, this graph pulls displacement, shear, and moment calculations to display the current Shear and Moment diagram along the X axis of the object.

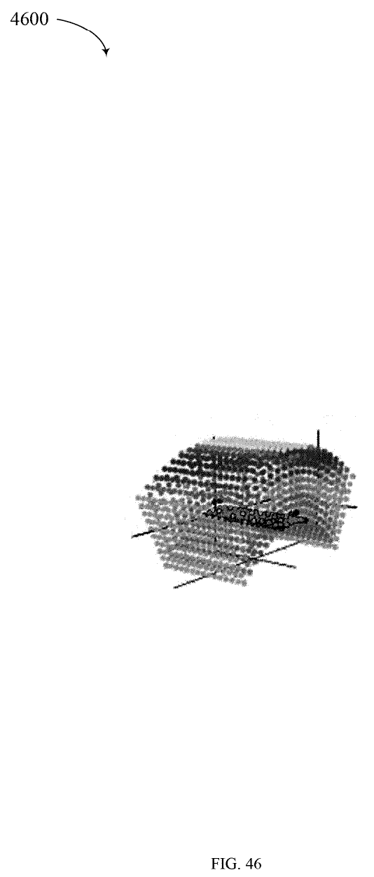

FIG. 46 illustrates a plot 4600 generated of the objects described herein. The plot 4600 is generated from the object with interlocking connectors as it is loaded with a bending force. The square nodes on the rectangular prism with interlocking connectors are tracked. Their positions within the camera view are then measured and calibrated. As the user applies a positive or negative bending force to the object, this graph pulls displacement and stress calculations to display the current position of the object in the XYZ plane and assigns a color to each node to represent the magnitude of stresses at each point within the object.

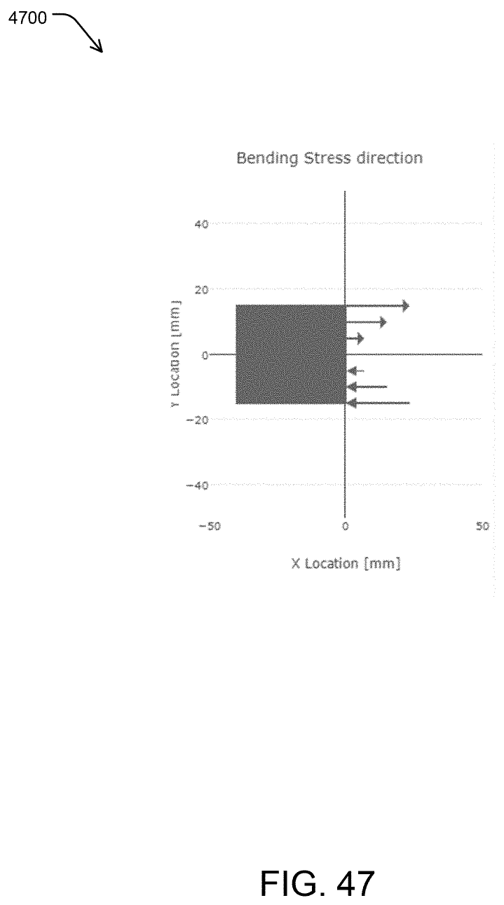

FIG. 47 illustrates a plot 4700 generated of the objects described herein. The plot 4700 is generated from the object with interlocking connectors as it is loaded with a bending force. The square nodes on the rectangular prism with interlocking connectors are tracked. Their positions within the camera view are then measured and calibrated. As the user applies a positive or negative bending force to the object, this graph pulls displacement and stress calculations to display the magnitude of the bending stress throughout the object in the XY plane using arrows of varying magnitudes and directions.

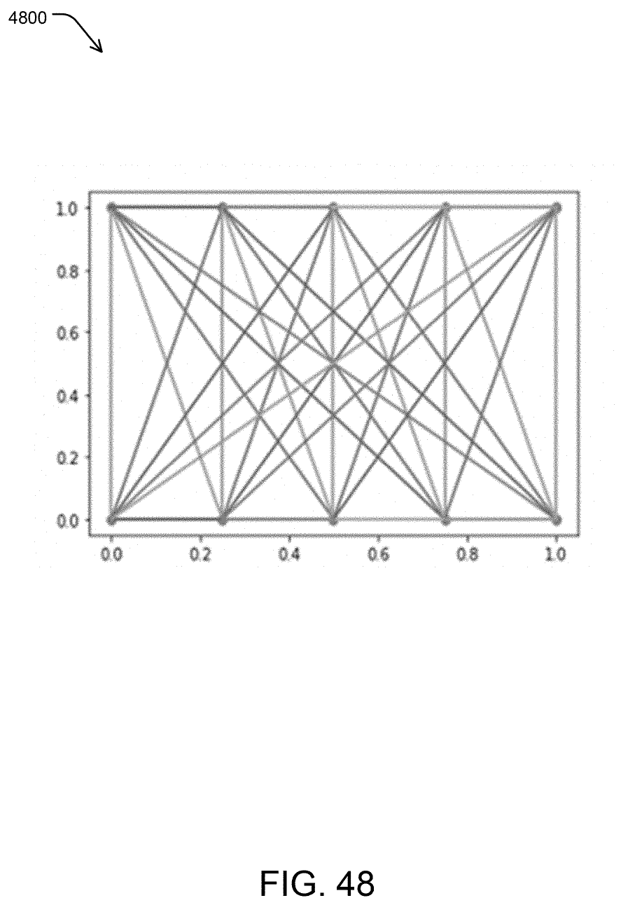

FIG. 48 illustrates a plot 4800 of optimization measurements of the objects described herein. Optimization measurements between all surface markings are shown in plot 4800. Individual location, size, shape, deformation, and prospective are taken for all surface markings. In addition, relationships between two or more of the surface markings are also considered. The angle, shape, distance, and deformation between all surface markings are also considered for measurements taken on each object in the optimization program.

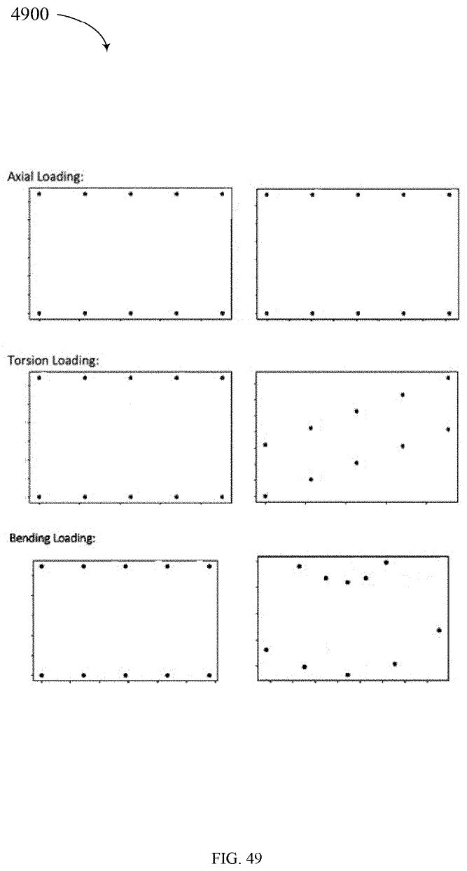

FIG. 49 illustrates plots 4900 of optimization measurements of the objects described herein. Loaded objects in classic mechanics loading scenarios are in the plots 4900 projected on to a 2D plane. Measurements are taken throughout the course of the loading environment or at the start and end to capture change in measure for all beam states. Axial loading used fundamental strain equations and Poisson's ratio to calculate changes in node location. Torsion utilized angle of twist formulations from our physical beams to model the deformation of the object. Three-point bending was created using numerical methods and bending equations.

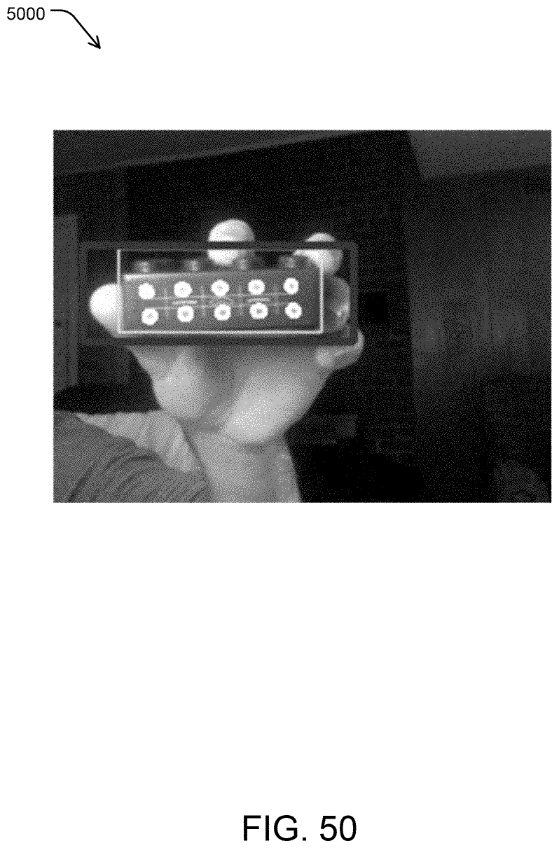

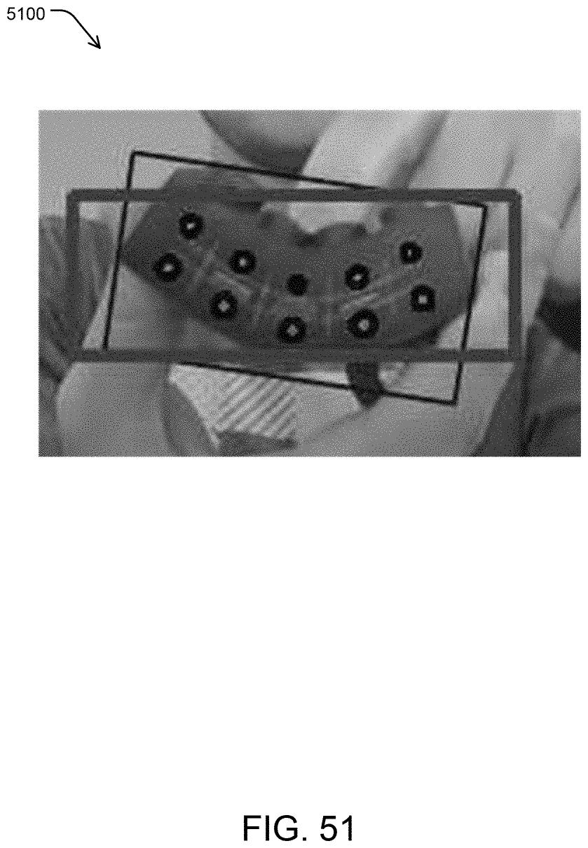

FIG. 50 illustrates a display 5000 on the interactive user interface of a user manipulating the objects described herein. FIG. 51 illustrates a display 5100 on the interactive user interface of a user manipulating the objects described herein. The interactive user interface may contain live feedback for the user or recorded indications of tracking. The display shows the object in the frame as well as guidance features placed on top of the image. Additionally, the tracking of the object is displayed for validation of correct segmentation to the user. The guidance feature may indicate ideal orientation for reduced tracking error, directions for users, measurements, or any other feedback for the purpose of guidance or data display.

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B. or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system comprising:
at least one object; and
a computing system comprising a tracking system configured to detect the object, wherein the computing system determines at least one attribute of the object based on input from the tracking system.

2. The system of claim 1, wherein the tracking system comprises at least one of a camera, a LiDAR sensor, an infrared camera, a sonar sensor, an ultrasound sensor, a coded light sensor, structured light sensor, and a time of flight sensor.

3. The system of claim 2, wherein the tracking system comprises a camera comprising at least one of a computer camera, a tablet camera, a document camera, mixed reality headset camera, webcam, tv camera, screen camera, embedded camera and a cellphone camera.

4. The system of claim 1, wherein the computing system further comprises a computing device comprising at least one of a tablet, a laptop, a phone, a microprocessor in an electronic device, and a desktop computer.

5. The system of claim 4, wherein the computing system further comprises a display device comprising a screen of at least one of a tablet, a laptop, a phone, and a desktop computer.

6. The system of claim 5, wherein the tracking system, a computing device, and the display device are integrated into a single device.

7. The system of claim 1, wherein the at least one object comprises a rigid body.

8. The system of claim 1, wherein the at least one object comprises a deformable body.

9. The system of claim 1, wherein the at least one object comprises a rectangular prism shape.

10. The system of claim 1, wherein the at least one object comprises a cylindrical shape.

11. The system of claim 1, wherein the at least one object comprises at least one surface feature.

12. The system of claim 11, wherein the at least one surface feature comprises at least one of a surface mark, a texture, a shape, and a physical feature of or on the object.

13. The system of claim 12, wherein the tracking system tracks the at least one surface feature.

14. The system of claim 13, wherein the at least one surface feature comprises a QR code and the computing device detects an attribute of the object based on the QR code.

15. The system of claim 1, wherein the at least one object comprise a plurality of objects connected to each other.

16. The system of claim 15, wherein each object of the plurality of objects comprises at least one connector configured to interface with at least one connector of another object of the plurality of objects.

17. The system of claim 1, further comprising a manipulation device configured to impart a force on the at least one object.

18. A method of detecting properties of at least one object with a system, the system comprising the at least one object, a tracking system, and a computer system, the method comprising:
capturing frames of the at least one object, wherein the tracking system comprises at least one camera and the at least one camera captures the frames of the object;
segmenting the object from an environment, wherein the computer system segments and isolates the object from the environment;
segmenting at least one surface feature from the object;
determining a position of the at least one surface feature; and
determining at least one property of the at least one object using the computing system.

19. The method of claim 18, further comprising displaying the results in the form of plots of the at least one object on a display device of the computing system.

20. The method of claim 18, further comprising manipulating at least one variable associated with the at least one object by the user.
